(19) United States
(12) Patent Application Publication
(10) Pub. No.: US 2006/0045981 A1
(43) Pub. Date: Mar. 2, 2006

(54) Pressure fed coating roller, roller coating device, automated coating apparatus using this device

(75) Inventors: Toshihiro Tsushi, Hyogo (JP); Shigeyuki Abe, Hyogo (JP); Haruo Hirai, Hyogo (JP)

Correspondence Address: FOLEY AND LARDNER LLP;SUITE 500, 3000 K STREET NW, WASHINGTON, DC, 20007, US

(73) Assignee: KANSAI PAINT CO., LTD

(21) Appl. No.: 10/517,636

(22) PCT Filed: Jun. 11, 2003
(86) PCT No.: PCT/JP03/07427

§ 371 Date: Aug. 9, 2005

(30) Foreign Application Priority Data
Jun. 14, 2002 (JP) 2002-174595
Jan. 21, 2003 (JP) 2003-012430
Jan. 21, 2003 (JP) 2003-012466
Jan. 21, 2003 (JP) 2003-012695

(51) Int. Cl. B05D 5/00; B05C 1/08; B05C 11/00; B05C 1/06

(52) U.S. Cl. 427/428.01; 118/258; 118/264

(57) ABSTRACT

An object of the present invention is to provide a coating device of the roller type which reduces a waste of coating material and distributes the coating material uniformly to the roller brush.

The coating device includes a sold cylindrical body (11) being solid except an axial center hole (13), and radial holes (14) radially extended from a plurality of positions of the axial center hole (11), a roller brush (12) applied to the outer periphery of the solid cylindrical body (11), coating-material press feeding pipes (24) connected to both ends of the axial center hole (13) of the solid cylindrical body (11), and an arm part (31) for supporting the solid cylindrical body (11) at both ends of the solid cylindrical body (11). Those components are entirely supported by a turnable support mechanism (40) and a vertically movable support mechanism (50).

### TECHNICAL FIELD

The present invention relates to a coating pressure feed roller, a roller coating device, a curved-surface operable roller coating device, and a automated coating apparatus using those devices and a coating method. More particularly, the invention relates to a roller coating well adaptable for the feeding of a coating material or the like to a roller brush by using a pump or the like.

### BACKGROUND ART

The roller coating device has been used in various fields. The roller coating device is used in an automobile manufacturing factory, for example. In the factory, the roller coating device is used for forming a protecting film on a surface of a coating film of the car in order to protect the coating film against rain water, iron powder, pollen, bird droppings and the like and hence to prevent coating quality deterioration.

In the known roller coating device, the roller is manually rotated in a coating material reservoir containing a coating material, and the coating material is infiltrated into the roller. This method is difficult in uniformly applying the coating material onto the entire roller, resulting in an uneven coating of the coating material on the roller. Such a process that the coating material is applied to the roller several times and then the coating material is infiltrated again into the roller, is repeated. This process involves many problems: it needs great man-hours, much labor costs and large working hours, and extension of the coating booth.

In this situation, an apparatus was developed which automatically pressure-feeds the coating material from the coating material reservoir to the roller by use of a pump. An automatic coating-material feeding apparatus was further developed which can handle a coating material of high viscosity. Further, this feeding apparatus is sized reduced.

One of the latest models of this type of the roller coating device is “Roller Type Coating Device”, filed by the Applicant of the present Patent Application in the form of a joint application (Patent Document 1).

[Patent Document 1]

JP-A-9-192584
   [Patent Document 2]
JP-A-57-75170
   [Patent Document 3]
JP-A-07-80399
   [Patent Document 4]
JP-A-2001-121068

FIGS. 29 and 30 are diagrams for explaining the roller type coating device, and FIG. 29 is a perspective view showing a roller type coating device, and FIG. 30 is an exploded perspective view showing the roller type coating device.

In FIGS. 29 and 30, reference numeral 80 is a roller type coating device. The roller type coating device is generally made up of a roller brush 82, a roller support 85, and a handle 88.

The roller brush 82 rolls on a coating film surface of a car, which is to be a coating surface, and applies a material onto the coating film surface. A roller support 85 rotatably supports the roller brush 82, and a handle 88 supports it and feeds a coating material to the roller brush 82.

The handle 88 includes a gripping part 88a gripped by a worker and an operation lever 88b. A frame body 86, shaped like a crank, is coupled to the front end of the gripping part 88a.

The frame body 86 is a coating material conduit made of a rigid metallic material, such as a stainless steel. A coating material feeding pipe is coupled to the back end of the gripping part 88a of the handle 88. The coating material feeding pipe is flexible so that the worker grips the gripping part 88a and continues the coating work while moving. The operation lever 88b permits and shuts off the feeding of a coating material pressure fed from the coating material feeding pipe toward the frame body 86.

A diffuser 83 is rotatably mounted on the roller support 85.

The diffuser 83, as shown in FIG. 30, includes a plurality of diffuser units 831 to 836. The diffuser units 831 to 836 take each a polygonal pillar having a star-like cross section, which includes a hollow part having a star-like cross section which radially expands from the center to the respective vertices, and a recess at the center of each of peripheral areas each between the vertices. The diffuser units 831 to 836 are successively arranged such that the top end of the hollowed part of each diffuser unit 831 to 836 diffuser unit communicates with the recessed parts of the diffuser units 83l to 836 adjacent to the former, and coating material reserving chambers are defined by the peripheral parts of the diffuser units 831 to 836 and the inner peripheral surface of the roller brush 82. The roller brush 82 covers the diffuser 83.

The roller brush 82 includes a cylindrical roller 82a of which both ends (as viewed in the axial direction) are opened, and a cylindrical brush element 82b applied to the outer periphery of this roller. Ejection orifices are formed in the roller 82a, while being arranged over the entire periphery of the roller, each orifice communicatively interconnecting the inner side and the outer side of the roller 82a over the entire periphery.

The roller type coating device 80 thus constructed is used in the following way. The worker grips the gripping part 88a of the handle 88 by hand, and brings the roller brush 82 into contact with the coating surface, and operates the operation lever 88b. A coating material is pressure fed to the coating material reservoirs in the diffuser 83 by way of a route of the gripping part 88a, the frame body 86, the roller support 85, and coating material feeding holes of a roller shaft 81. The coating material is dispersedly introduced into the coating material reserving chambers defined by the peripheral parts of the diffuser units 831 to 836 and the inner peripheral surface of the roller brush 82 by openings each between the top ends of the hollowed part of each diffuser unit 831 to 836 and the recessed part of each diffuser unit 831 to 836. The coating material that is dispersedly introduced into the coating material reserving chambers is jetted out to the outer periphery of the roller 82a through the eject orifices, and infiltrated into the brush element 82b. In a state that the coating material has sufficiently infiltrated into the brush element 82b of the roller brush 82, the worker presses the roller brush 82 against the coating film surface, and rolls the roller brush 82 on the coating film surface, so that the coating material having permeated into the brush element 82b is applied to the coating film surface.

The roller type coating device 80 has the following advantages. In the coating operation, the roller brush 82 smoothly rolls on the coating surface, while not being slid, even though its construction is simple and a viscosity of the coating material is high. Further, the roller brush 82 rotates without any interruption. The coating material may be coated uniformly. There is no leakage of the coating material from between the mounting part and the sliding part. There is no chance that the coating material drops from the roller type coating device 80 and resultantly, dirt sticks to the car body, and working environment is deteriorated. The lowering of the yield of a coating material is avoided.

The inventor(s) found that the roller type coating device mentioned above still involve the following problems.

1) To uniformly apply a coating material on the coating film surface, it is necessary to always infiltrate a sufficient amount of a coating material into the star-like hollow part and the coating material reserving chambers. Accordingly, after the coating work ends, a considerable amount of coating material is left in the diffuser 83. The coating material is wasted, and the coating material flows out therefrom to possibly soil the surrounding. To wash off the dirt, much labor is needed.

2) In the roller type coating device, the roller shaft 81 is passed through the axial center of the drum. Accordingly, the number of parts is large, and much labor is needed for washing the roller shaft 81.

3) Further, in the roller type coating device, a coating material is fed into the roller from only one end thereof, and hence the coating material sufficiently pressurized does not reach the fore end thereof. Accordingly, it is difficult to uniformly apply the coating material to the entire roller.

4) And, in the roller type coating device, only one end of the roller is supported in a cantilever fashion. To uniformly apply a force over the entire roller, a skill is needed. Accordingly, the roller type coating device is not easy to handle for the layman.

In the case of a coating film formed by use of the roller type coating device, a difference of a film thickness is great between both ends of the roller part. Therefore, a sufficient film thickness cannot be secured. For this reason, it is necessary to apply the recoating to the coated surface having an insufficient thickness. However, it is difficult to secure a uniform coating by the recoating.

The roller type coating device of the type in which a coating material is pressure fed to the roller from both ends of the roller and the roller is supported at both ends, is known as disclosed in Patent Document 2.

FIG. 31 is a plan view showing the roller type coating device (the roller is illustrated by a phantom line). In the figure, reference numeral 101 is a coating-material feeding pipe; 102 is a roller body; 103 is a roller core; 104 is a coating material discharging port; 105 is a hollow L type joint; 106 is a relay pipe; 107 is a ball; 108 is a handle/coating-material feeding pipe; and 109 is a partitioning plate.

A coating material coming in through the handle/coating-material feeding pipe 108 branches off into right and left relay pipes 1006. The coating material enters the coating-material feeding pipe 101 by way of the hollow L type joint 105, and flows out of the coating material discharging port 104 and flows through the roller core 103 to the roller body 102. And it is uniformly applied to an object to be coated.

The roller type coating device is especially effective when it is used for a case where in coating a vertical wall or the like, the roller body 102 is vertically raised and rolled parallel to the floor. In this case, the balls 107 close the inlet of the lower relay pipe 106. Accordingly, the coating material flows into the coating-material feeding pipe 101 only from the lower relay pipe 106; it reaches the partitioning plate 109; it flows from the partitioning plate 109 and flows out to the roller through the upper coating material discharging port 104. No coating material is supplied from the relay pipe 106. The coating material flows to the lower side of the roller body 102 by gravity. Therefore, even if the coating is carried out in a state that the roller body 102 is vertically raised, the coating material may uniformly be applied to the object to be coated.

The roller type coating device still involves the following problems to be solved.

1) In the document, the roller core 103 is not discussed in detail. Then, it will be estimated that the roller core includes a number of known passages or a structure like a sponge. If so, a considerable amount of coating material will stay within the roller. Accordingly, the technique under discussion involves the same problem as of the roller type coating device described in Patent Document 1.

2) In the roller type coating device, the coating-material feeding pipe 101 is passed through the axial center of the drum. Accordingly, the technique under discussion involves the same problem as of the roller type coating device described in Patent Document 1.

3) In this roller type coating device, the partitioning plate 109 is provided at the center. The coating material is pressure fed to the roller from both ends of the roller. Even if a pressure difference is present between the coating materials on both sides of the partitioning plate 109, the pressure difference is not removed since the partitioning plate 109 is present. As a result, the thicknesses of the resultant coatings formed by the coating materials fed from both sides of the partitioning plate 109 are different from each other. Further, because of the presence of the partitioning plate 109, the same phenomenon as that in the case where the coating material is fed from only one end of the roller occurs. The coating material having a sufficient pressure fails to reach the partitioning plate located on the deep part of the coating-material feeding pipe 101, and it is difficult to uniformly coat the object to be coated.

Thus, the problems mentioned above cannot be solved by the roller type coating device described in Patent Document 2 in which the coating material is fed to the roller from both ends of the roller and the roller is supported at both ends thereof.

None of those conventional roller type coating devices including the last mentioned device are not automated. Even if the surface to be coated is flat, the surface is manually coated by using the roller. That is, the coating process is not automated. When the roller type coating device is applied to the coating of an object to be coated of which the surface to be coated is curved, it is difficult to apply the roller brush uniformly over the curved surface. Accordingly, it is considered that it is more difficult to automatize such a coating work.

The spray coating process is exclusively employed for the automatic coating of the coating material.

In the spray coating process, the coating material sprayed from the nozzle becomes dust around a pattern of coating material. Therefore, the uniform coating is impossible. The coating film formed by the dust part is manually peeled off, and the peeling-off work needs considerably troublesome labor. Thus, the automatic coating apparatus of the spray type has practically been used, but is still unsatisfactory in its performances.

For the above background reasons, a first object of the present invention is to reduce a waste of coating material and to distribute the coating material uniformly to the roller brush. The invention provides a coating pressure feed roller, and a roller coating device which is capable of coat the coating material uniformly coating a coated surface having a curved surface, by using the coating pressure feed roller, viz., a roller coating device which is effectively operable for the coating of a curved surface. Further, the invention provides an automatic roll coating device which is capable of uniformly coating even a surface to be coated as a curved surface with the coating material by using the curved-surface operable roller coating device.

To achieve a uniform finish quality of the coating, which is free from individual difference of the workers, it is necessary to automatize the coating process by using the coating robot. The conventional and known roller coating device (one- and both-end coating pressure feed rollers) is not suitable for the automatic coating process and hence, it is not automated. Even in the case of coating the flat surface, the worker manually coats that surface with the coating material by using the roller. That is, the coating process is not automated. When the roller coating device is applied to the coating of an object to be coated, of which the coating surface is a curved surface, it is difficult to apply the roller brush uniformly over the curved surface. Accordingly, it is considered that it is more difficult to automatize such a coating process.

A second invention is made to solve the above problem, and has a second object to eliminate the waste of the coating material and to provide a automated coating apparatus which 1) uses the one-end or both-end coating pressure feed roller (referred to as a “coating pressure feed roller”) according to the first invention, which is capable of uniformly distributing the coating material to the roller brush, 2) feeds the coating material from an oil drum storing the coating material to a coating material tank, and by stirring the coating material in the tank, by removing dusty materials from the coating material, and then 3) feeds the most suitable amount of coating material to the coating pressure feed roller in the coating booth, and 4) causes the robot device according to the first invention to automatically execute a roller-basis coating process to thereby automatically and uniformly coat even a curved coated surface with the coating material.

Objects to be coated were actually coated with the coating material by using the automated coating device according to the second invention. The result is that the coating of the curved components of the automobile, such as hood, roof, trunk, bumper, fender, or door was excellent.

It was found that in the coating by the automated coating apparatus, one problem to be solved is present. That is, when a rectangular area is coated, a coating film on a peripheral edge of the rectangular area is thicker than on the remaining portion.

To solve the problem, a third invention is directed to solve the problem, and has a third object to provide a coating method which is capable of making a thickness of a coating film on the square area uniform over its entire area by using the automated coating device.

### DISCLOSURE OF THE INVENTION

To achieve the first object, a coating pressure feed roller defined in claim 1 comprises: a solid cylindrical body being solid except an axial center hole passed through the axial center of the solid cylindrical body, and radial holes radially extended from a plurality of positions of the axial center hole; and a roller brush applied to the outer periphery of the solid cylindrical body.

With such a construction, a volume occupied by a coating material in an area of the solid cylindrical body is reduced. There is no need of the roller shaft, which is needed in the conventional coating device. The remaining coating material after the coating work ends is small in amount, a waste of coating material is small, maintenance of the coating device is easy, and the number of component parts is reduced.

A coating pressure feed roller defined in claim 2 comprises: a plurality of divided roller brush assemblies each formed with a solid cylindrical body being solid except an axial center hole passed through the axial center of the solid cylindrical body, and radial holes radially extended from a plurality of positions of the axial center hole, and a roller brush applied to the outer periphery of the solid cylindrical body; an elastic member by which the divided roller brush assemblies are pulled to each other; and a flexible tube passing through the axial center holes of all of the divided roller brush assemblies; wherein holes formed in the flexible tube are aligned with the radial holes.

With such a construction, as the invention defined in claim 1, a volume occupied by a coating material in an area of the solid cylindrical body is reduced There is no need of the roller shaft, which is needed in the conventional coating device. The remaining coating material after the coating work ends is small in amount, a waste of coating material is small, maintenance of the coating device is easy, and the number of component parts is reduced. Further, the coating pressure feed roller is operable adaptively for a surface locally curved. Accordingly, the curved surface may be coated excellently.

In a coating pressure feed roller defined in claim 3, which depends from claim 1 or 2, a groove extending in the circumferential direction, which is connected to the outlets of the radial holes, is formed in a surface of the solid cylindrical body.

With such a feature, the coating material flowing out of the radial holes swiftly spreads in the circumferential direction along a circumferential groove. As a result, the coating material is spread over the entire surface of the roller to thereby secure a uniform coating.

A roller coating device defined in claim 4, which depends from claim 1 or 2, comprising: a coating pressure feed roller defined by any of claims 1 to 3; coating-material press feeding pipes connected to both ends of the axial center hole of the solid cylindrical body of the coating pressure feed roller; and an arm part for supporting the coating pressure feed roller at both ends of the coating pressure feed roller.

With this feature, the coating material is supplied from both ends of the roller to the roller, and is supported at both ends. A liquid pressure is uniform over the axial center hole passing through the axial center. A pressing force applied to the coating pressure feed roller is uniform, so that the coating material is distributed over the entire roller.

A curved-surface operable roller coating device defined in claim 5 comprising: a coating pressure feed roller; coating-material press feeding pipes for pressure feeding the interior of the coating pressure feed roller from both ends of the coating pressure feed roller; an arm part for supporting the coating pressure feed roller at both ends of the coating pressure feed roller; a turnable support mechanism for supporting the arm part such that the arm is rotatable in a plane parallel to a vertical surface including the axis of the coating pressure feed roller; and a vertically movable support mechanism for supporting the arm part such that the arm part is vertically movable.

With such a construction, the support displaces the roller brush in conformity with a coated surface. The resultant coating is free from spots. The vertically movable support mechanism brings the roller brush into contact with the coated surface at a fixed pressure. Therefore, a coating having a uniform thickness is secured.

In a curved-surface operable roller coating device defined in claim 6, the coating pressure feed roller defined in claim 5 is the coating pressure feed roller defined by any of claims 1 to 3.

When the curved-surface operable roller coating device defined in claim 5 is used, the arm part is turned in a vertical plane including an axis of the roller and vertically movable. Although any special limitation by a type of coating pressure feed roller used is imparted, such a construction reduces the remaining coating material amount, and eliminates a waste of coating material. Maintenance is easy, and the coating material is spread over the entire roller surface. Therefore, the thickness uniformity of the coating is enhanced, and a favorable use handiness is secured.

An automatic coating apparatus of the roller type defined in claim 7 comprising: a three-dimensionally moving robot being movable in three dimensional directions, the curved-surface operable roller coating device defined by claim 5 or 6 being attached to the tip of arms of the robot; a robot control unit for controlling the three-dimensionally moving robot; a pump control unit for controlling a flow rate of a coating material to be pressure fed to the curved-surface operable roller coating device.

With such a construction, robot operation (the number of revolutions of the roller brush, pressing force), the amount of coating material fed, liquid feeding pressure and the like may automatically be set allowing for viscosity of the coating material, coating material environments (temperature, humidity, etc.) and the like. A uniform roller coating may be automated.

To achieve the second object, there is provided a automated coating apparatus (defined in claim 8) having a coating material tank supplied with a coating material from a coating material can, a coating device for coating a coating material on an object to be coated, a piping ranging from the coating material tank to the coating device, and a pump, provided in the piping, for feeding the coating material to the coating device. In the automated coating apparatus, the coating device comprising: a coating pressure feed roller including a solid cylindrical body being solid except an axial center hole passed through the axial center of the solid cylindrical body, and radial holes radially extended from a plurality of positions of the axial center hole, and a roller brush applied to the outer periphery of the solid cylindrical body; a curved-surface operable roller coating device including coating-material press feeding pipes connected to both ends of the axial center hole of the solid cylindrical body of the coating pressure feed roller, an arm part for supporting the coating pressure feed roller at both ends of the coating pressure feed roller, a turnable support mechanism for supporting the arm part such that the arm is rotatable in a plane parallel to a vertical surface including the axis of the coating pressure feed roller, and a vertically movable support mechanism for supporting the arm part such that the arm part is vertically movable; a three-dimensionally moving robot being movable in three dimensional directions, the curved-surface operable roller coating device defined by claim 5 or 6 being attached to the tip of arms of the robot; a robot control unit for controlling the three-dimensionally moving robot; and

a coating material flow rate control unit for controlling a flow rate of a coating material to be pressure fed to the curved-surface operable roller coating device.

By convention, it is difficult to spray a coating material of high viscosity, such as aqueous coating material for coating film protection. This hinders the automating of the coating process using such a coating material. For this reason, the coating using the aqueous coating material is manually performed using the roller. To automate the coating process by the roller, it is difficult to adapt the roller for a curved surface. This makes it impossible to automate the coating process.

The coating device of the roller type with the both-end pressure feed roller is able to adapt for the curved surface. By using the coating device, the coating process by the coating roller may be automated.

A automated coating apparatus (defined in claim 9) has a coating material tank supplied with a coating material from a coating material can, a coating device for coating a coating material on an object to be coated, a piping ranging from the coating material tank to the coating device, and a pump, provided in the piping, for feeding the coating material to the coating device. In the automated coating apparatus, the coating device comprising: a coating pressure feed roller including a solid cylindrical body being solid except an axial center hole passed through the axial center of the solid cylindrical body, and radial holes radially extended from a plurality of positions of the axial center hole, and a roller brush applied to the outer periphery of the solid cylindrical body; a curved-surface operable roller coating device including coating-material press feeding pipes connected to one end of the axial center hole of the solid cylindrical body of the coating pressure feed roller, an arm part for supporting the coating pressure feed roller at one end of the coating pressure feed roller, a turnable support mechanism for supporting the arm part such that the arm is rotatable in a plane parallel to a vertical surface including the axis of the coating pressure feed roller, and a vertically movable support mechanism for supporting the arm part such that the arm part is vertically movable; a three-dimensionally moving robot being movable in three dimensional directions, the curved-surface operable roller coating device defined by claim 5 or 6 being attached to the tip of arms of the robot; a robot control unit for controlling the three-dimensionally moving robot; and a coating material flow rate control unit for controlling a flow rate of a coating material to be pressure fed to the curved-surface operable roller coating device.

The coating device of the roller type with the one-end coating pressure feed roller is also adaptable for the curved surface, like the coating device defined in claim 8. Accordingly, the coating process which cannot be automated by conventional art, can also be automated.

In a automated coating apparatus defined in claim 10, which depends from claim 8 or 9, a solution filter for removing foreign matters mixed into the coating material is provided in the piping ranging from the coating material tank to the coating device.

Since the filter filters out foreign materials, beautiful coating is secured, and device trouble by the foreign materials is prevented.

In a automated coating apparatus defined in claim 11, which depends from claims 8 or 9, a liquid quantity stabilizer using a flow meter, for controlling a flow rate of coating material in order to eliminate a variation of a flow rate of coating material within the piping and to keep constant an amount of coating material coated by the coating device, is provided in the piping ranging from the coating material tank to the coating device.

The liquid quantity stabilizer keeps the amount of coating material coated by the coating device at a fixed value. The resultant coating is beautiful with no shade.

In a automated coating apparatus defined in claim 12, which depends from claims 8 or 9, a heat exchanger for adjusting temperature of the coating material in the coating device to an optimum temperature and supplying the coating material temperature adjusted is provided in the piping ranging from the coating material tank to the coating device.

With such a construction, the coating material in the coating device may be adjusted to have an optimum temperature. Accordingly, the viscosity of the coating material may be kept constant through the four seasons. A predetermined control may be executed at all times.

A automated coating apparatus defined in claim 13, which depends from claim 8 or 9, further comprises a return piping for returning the remaining coating material of the coating material having been fed from the coating material tank to the coating device, the remaining coating material being left while not used for coating.

The remaining coating material may be returned to the coating material tank. Accordingly, the coating material may be circulated irrespective of use of the coating material. A necessary amount of coating material may be used whenever it is required. The control of the discharge quantity of coating material is easy.

In a automated coating apparatus defined in claim 14, which depends from claim 8 or 9, the fore end of the return piping is projected into a liquid level within the coating material tank and is bent in the circumferential direction along the side wall the coating material tank.

With such a technical feature, the coating material in the coating material tank is stirred with a simple construction.

A automated coating apparatus defined in claim 15, which depends from claim 8 or 9, further comprises a coating material color select valve provided in the piping ranging from the coating material tank to the coating device; a piping for guiding a detergent from a detergent tank to the coating material color select valve; and a pump, provided in the piping, for supplying a detergent to the coating material color select valve.

With such a technical feature, the coating device may be washed with a simple construction.

To achieve the third object, there is provided a coating method (claim 16) for coating an object to be coated in a manner that a roller is rolled while a coating material is pressure fed from the interior of the roller to the outer periphery thereof, in which a predetermined long area is coated from one end to the other end by the coating pressure feed roller, the coating pressure feed roller is stopped at the other end, to coat a long area adjacent to the long area, the coating pressure feed roller is moved to one of the ends of the adjacent long area, and the long area is coated again toward the other end, and the coating operations are sequentially repeated to finally coat a broad area. In the coating method, as a first step, an area of the broad area except an area as a maximum corresponding to a width of the coating pressure feed roller, which is located inside from the both ends of the broad area is entirely coated by the coating method, and as a second step, the coating pressure feed roller is rolled from a first long area to a final long area in the uncoated area, while discharging no coating material or a small amount of coating material.

By such a coating method, a rectangular area maybe coated uniformly over its entire area by using the coating robot which may be automated.

In a coating method defined in claim 17, in the coating method of claim 16, the coating pressure feed roller is rolled while discharging no coating material or a small amount of coating material, in a final long area in the broad area.

This construction eliminates formation of stagnant coating material at the end of the uppermost area. A more fine and uniform thickness of the coating in the upper part of the rectangular area is secured.

In a coating method defined in claim 18, in the coating method of claim 16, as the amount of coating material stagnating at the end increases, the width of the uncoated area is increased.

With this feature, a thickness of the coating film may be made uniform even if the viscosity of the coating material varies by the kind of coating material and coating temperature.

In a coating method defined in claim 19, flat and curved portions to which the coating pressure feed roller is followable, such as hood, roof, trunk, bumper, fender or door of an automobile, is coated by the coating method defined by any of claims 16 to 18, and portions where the coating pressure feed roller is not followable, is coated manually by a brush or a roller, or automatically by a coating robot including a small roller smaller than the coating pressure feed roller or a slit nozzle.

This feature enables the portions to which the coating pressure feed roller is followable, may be coated.

In a coating method in use for an automobile (claim 20), in the coating method defined in claim 19 which includes at least one coating pressure feed roller for coating an object to be coated in a manner that a roller is rolled while a coating material is pressure fed from the interior of the roller to the outer periphery thereof, at least one of the hood, roof, trunk, bumper, fender and door is coated with a first coating pressure feed roller, and at least one of components other than the components coated by the first coating pressure feed roller is coated with a second coating pressure feed roller.

With this feature, the automobile may be coated uniform in thickness, and efficiently.

### BRIEF DESCRIPTION OF THE DRAWINGS

FIG. 1 is a perspective view conceptually showing a coating device including a coating pressure feed roller, which is a first embodiment of the present invention.

FIG. 2 is a longitudinal sectional view showing a roller brush assembly shown in FIG. 1 when viewed in the axial direction.

FIG. 3 is a cross sectional view taken on line A-A in FIG. 2.

FIG. 4 show diagrams showing structures of a solid cylindrical body each of which contains a number of radial holes which is reduced by the invention: FIGS. 4(a) to 4(f) show the solid cylindrical body structures containing 2 to 8 radial holes; and FIG. 4(g) shows a diagram of a conventional roller.

FIG. 5 is an exploded perspective view showing a roller brush assembly 10 shown in FIG. 1.

FIG. 6 is a diagram for explaining operation of a turnable support mechanism 40 in FIG. 5: FIG. 6(a) shows a state that the roller rolls on a flat surface; FIG. 6(b) shows a state that the roller rolls on a surface curved upward to the right; and FIG. 6(c) shows a state that the roller rolls on a surface curved downward to the left.

FIG. 7 is a diagram showing a vertically movable support mechanism 50 in a third embodiment of the invention.

FIG. 8 is a diagram for explaining operations of the vertically movable support mechanism 50 of FIG. 7: FIG. 8(a) shows a state that the roller rolls on a low surface; and FIG. 8(b) shows a state that the roller rolls on a high surface.

FIG. 9 is a diagram showing a modification of the roller brush assembly of FIG. 2: FIG. 9(a) is a cross sectional view showing the coating of a flat surface, and FIG. 9(b) is a cross sectional view showing the coating of an irregular surface.

FIG. 10 is a diagram showing an outward appearance of a roller brush assembly including five divided rollers: FIG. 10(a) is a view showing the roller brush assembly when it is a normal state; FIG. 10(b) is a view showing the roller brush assembly when the divided rollers are separated; and FIG. 10(c) is a partially enlarged view showing the roller brush assembly of FIG. 6(b).

FIG. 11 is a diagram showing an automatic coating apparatus which is a fourth embodiment of the invention.

FIG. 12 is a block diagram showing a central control unit in FIG. 11.

FIG. 13 is a diagram showing an arrangement of a automated coating apparatus which is a first embodiment of a second invention.

FIG. 14 is a diagram for explaining a coating material tank used in the second invention: and FIG. 14(a) is a longitudinal sectional view showing the coating material tank; and FIG. 14(b) is a transverse cross sectional view showing the same.

FIG. 15 is a longitudinal sectional view showing a pump used in the second invention.

FIG. 16 is a diagram showing an energy-saving coating material cycling system, which is installed to a coating booth for an automobile.

FIG. 17 is a longitudinal sectional view showing a filter used in the second invention.

FIG. 18 is a diagram showing a heat exchanger used in the second invention.

FIG. 19 is a block diagram showing an automatic coating apparatus using a liquid quantity stabilizer which is an embodiment of the second invention.

FIG. 20 is a timing chart showing a variation of a flow rate of an aqueous coating material with respect to time in the liquid quantity stabilizer of FIG. 19, and operations of respective portions in the device.

FIG. 21 is a timing chart showing operation of the liquid quantity stabilizer of FIG. 19 when a coating material discharge flow rate varies.

FIG. 22 is a diagram for explaining a coating direction of the coating operation performed by the coating pressure feed roller according to the first invention when a coating robot is used: FIG. 22(a) shows a right directional coating process, which is carried out by the coating pressure feed roller attached to a robot arm; and FIG. 22(b) shows a left directional coating process which is carried out by the same.

FIG. 23 is a diagram for explaining a hood coating of an automobile by a conventional coating method: FIG. 23(a) is a plan view for explaining an order of coating operations; and FIG. 23(b) is a cross sectional view showing the result of the coating operation.

FIG. 24 is a diagram showing an automatic coating apparatus using a liquid quantity stabilizer which is an embodiment of a third invention.

FIG. 25 is a conceptual diagram typically showing how a roller flattening device in FIG. 24 is used by the coating robot within a coating booth.

FIG. 26 is a diagram for explaining a coating method of the third invention by using the coating of a hood of an automobile: FIG. 26(a) is a plan view for explaining an order of coating operations; and FIG. 26(b) is a cross sectional view for explaining the result of the coating.

FIG. 27 is a plan view showing three examples of portions of an automobile to which the coating method of the third embodiment may be applied: FIG. 27(a) shows a hood; FIG. 27(b) shows a roof; and FIG. 27(c) shows a trunk.

FIG. 28 is a plan view an example of an efficient coating process by using coating robots 171 and 172 shown in FIG. 25.

FIG. 29 is a perspective view showing a known roller type coating device.

FIG. 30 is an exploded perspective view showing the roller type coating device of FIG. 29.

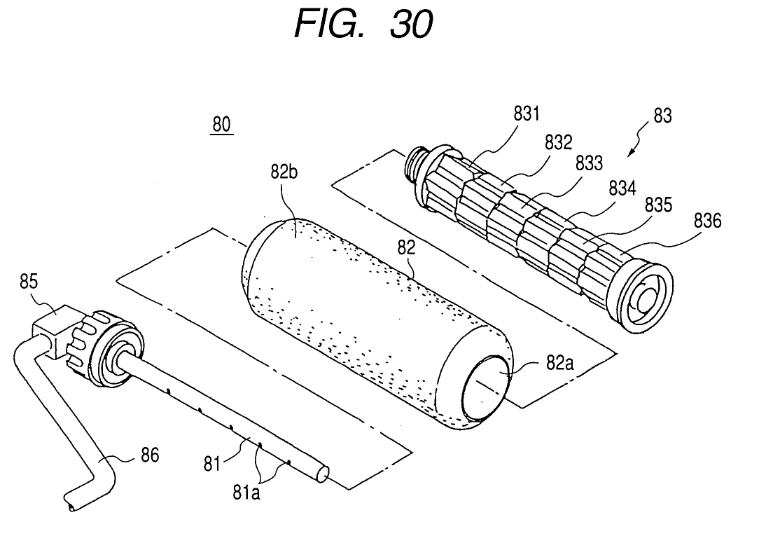

FIG. 31 is a plan view showing a known roller type coating device in which a coating material is pressure fed to the device from both ends and the roller is supported at both ends.

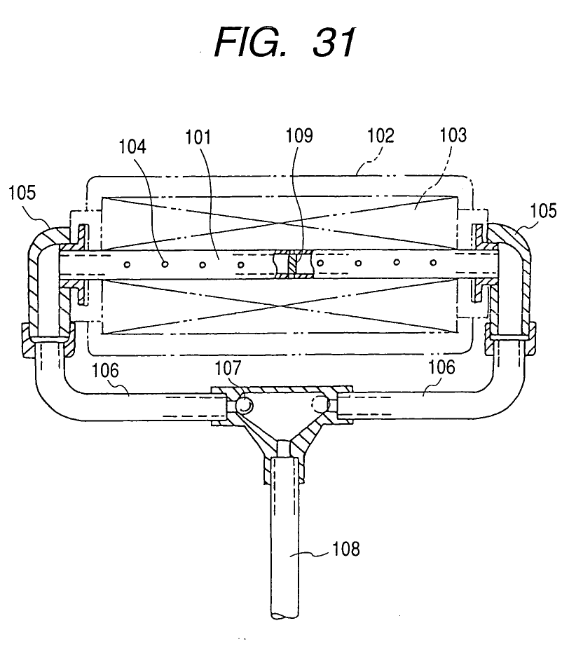

In those figures, reference numerals and names indicated by the reference numerals are as follows:
10 roller brush assembly
11 solid cylindrical body
12 roller brush
13 axial center hole
14 radial hole
15 groove
16 flange
17 female screw 17
18 drum
19 hole
20, 21 gasket
22 disc
23 bolt
24 coating-material press feeding pipe
30 support
31 arm
32 lower frame
33 intermediate frame
33a intermediate frame table
34 upper frame
40 turnable support mechanism
41 plate
42 pin
50 vertically movable support mechanism
51 arm
52 pin
53 spring
54 adjusting screw
60 roller brush assembly
61 divided solid cylindrical body
61a divided roller
61b tension spring
61c gasket
62 roller brush
63 axial center hole
64 radial hole
65 Teflon tube
66 disc
66a flange
66b female screw 66b
68 drum
69 bolt
70 automatic coating apparatus
71 coating robot
72 curved-surface operable roller coating device
73 coating-material pressure feed pump
731 pump control unit
74 robot body
741 movable part
742 robot control unit
75 central control unit
750 C PU
751 RAM
752 ROM
753 display device
754 keyboard
755 interface
76 temperature sensor
77 humidity sensor
90 roller flattening device
92a, 92b contact roller
93a, 93b rotary shaft
94a, 94b gear
95 drive gear
96 motor
97 mounting plate
100 coating material preparing chamber
110 coating material feeding system
111 coating material can
112 pump
112A pump drive motor
112B pump chamber incurvated part
112C latching step
112D lower collar
112E in-flow passage recess
112F discharge passage recess
112G partitioning wall
112H upper collar
112J first recess
112K second recess
112L partitioning wall
112M surge tank cover
112N surge diaphragm
112N1 suction side surge diaphragm
112N2 discharge side surge diaphragm
112P pump chamber
112Q pulsating pressure chamber
112S discharge passage
112T suction passage
112U discharge side check valve
112V suction side check valve
112W partitioning wall
1122 suction valve seat
1123 valve seat body
1124 discharge valve seat
1125 suction-side check-valve receiving recess
1127 pump cover
1128 pump diaphragm
1129 pulsating pressure guide passage
113 regulator
113A scale gauge
114 solution filter
115 coating material tank
115a tank body
115b lid
115c replenishing piping 115c
115h feeding piping 115h
115e bottom
115f screen mesh
115g side wall
116 pump
116A pump drive motor
120 regulator
120A scale gauge
121 solution filter
130 heat exchanger
131a cold water tank
131b warm water tank
132a cold water tank
132b warm water tank
133a to 133f piping 133f to 133f
134a three-way valve
136 feed pipe
136 heat exchanging part
136a primary coil (radiation part)
136b secondary coil
136c feed pipe
136d discharge pipe
140 liquid quantity stabilizer
141 air operation type control valve
142 flow meter
143 counter
144 barrier amplifier
145 analog memory unit
146 adjusting meter
147 converter
151 to 154 piping
155 return piping
160 detergent feeding system
161 detergent drum
162 pump
162A pump drive motor
163 detergent filter
170 coating booth
171, 172 coating robot
171a, 172a both-end coating pressure feed roller
173, 174 CCV
175, 176 piping
221 coating robot arm
222 curved-surface operable coating pressure-feed roller
223 coating pressure feed roller brush
224 coated surface
400 erector pump
410 suction port
420 inlet
430 in-flow pipe
440 outlet
450 pump chamber
460 funnel inner surface
500 coating material filter
501, 502 joint
503 filter cartridge
504 guide spring
505 various measuring gauge connection part
511 head
511a inlet nozzle
512 bottom plate cover
513 shell
514 rod
515 filter housing

### BEST MODE FOR CARRYING OUT THE INVENTION

The inventions of the present Patent Application will be described in detail with reference to the accompanying drawings.

### First Embodiment of a First Invention

Embodiments of a first invention will first be described.

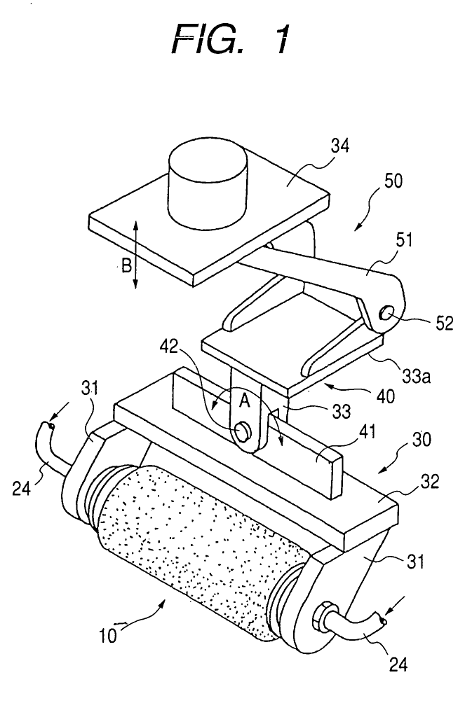

FIG. 1 is a perspective view conceptually showing a coating device including a coating pressure feed roller, which is a first embodiment of a first invention. In FIG. 1, the coating pressure feed roller according to the first embodiment of the invention is a part of a roller brush assembly 10.

The coating pressure feed roller according to the first embodiment of the invention will first be described.

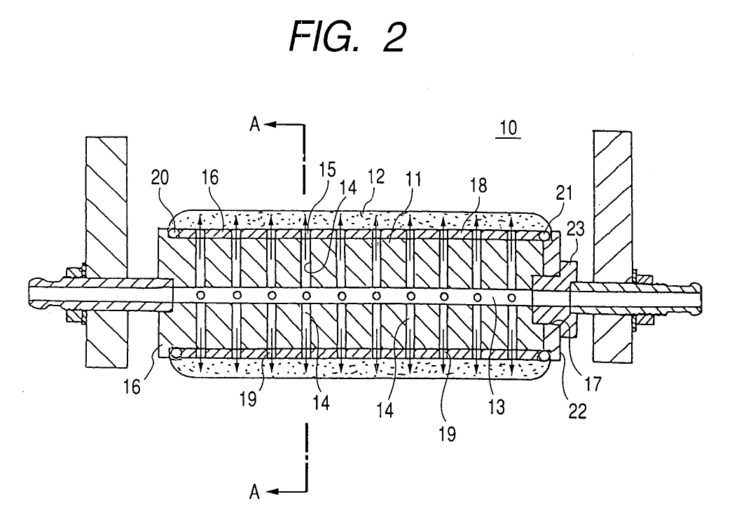

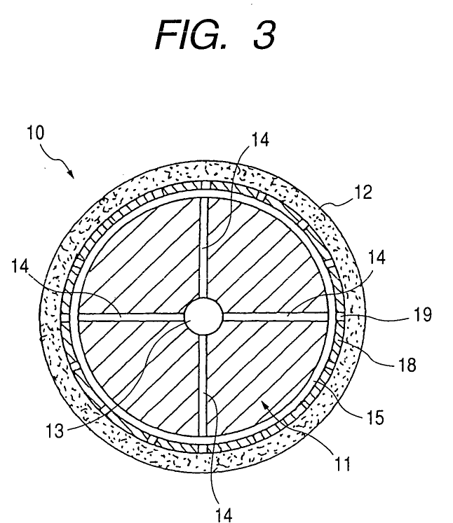

FIG. 2 is a longitudinal sectional view showing the roller brush assembly when viewed in the axial direction. FIG. 3 is a cross sectional view taken on line A-A in FIG. 2.

The roller brush assembly 10, as shown in FIGS. 2 and 3, includes a solid cylindrical body 11 and a roller brush 12 applied to the outer periphery of the solid cylindrical body 11 in a fitting manner.

The solid cylindrical body 11 is made of synthetic resin, metal or the like, and is solid. It has a solid structure in which a coating material feeding passage is formed only with an axial center hole 13 passed through the axial center of the solid cylindrical body, and radial holes 14 radially extended from a plurality of positions of the axial center hole 13.

As shown in FIG. 3, a total of four radial holes 14 are formed which radially extend from the axial center hole 13 while being angularly spaced from one another by 90°. In the embodiment, four radial holes 14 are used; however, the number of radial holes is not limited to four, as a matter of course. That the number of radial holes 14 is not large is one of features of the invention. The reason for this follows. If the number of radial holes is large, a large amount of coating material stays in the radial holes. Accordingly, the roller of the invention is not distinguished from the conventional roller in which a large amount of coating material stays, in the operations and beneficial effects.

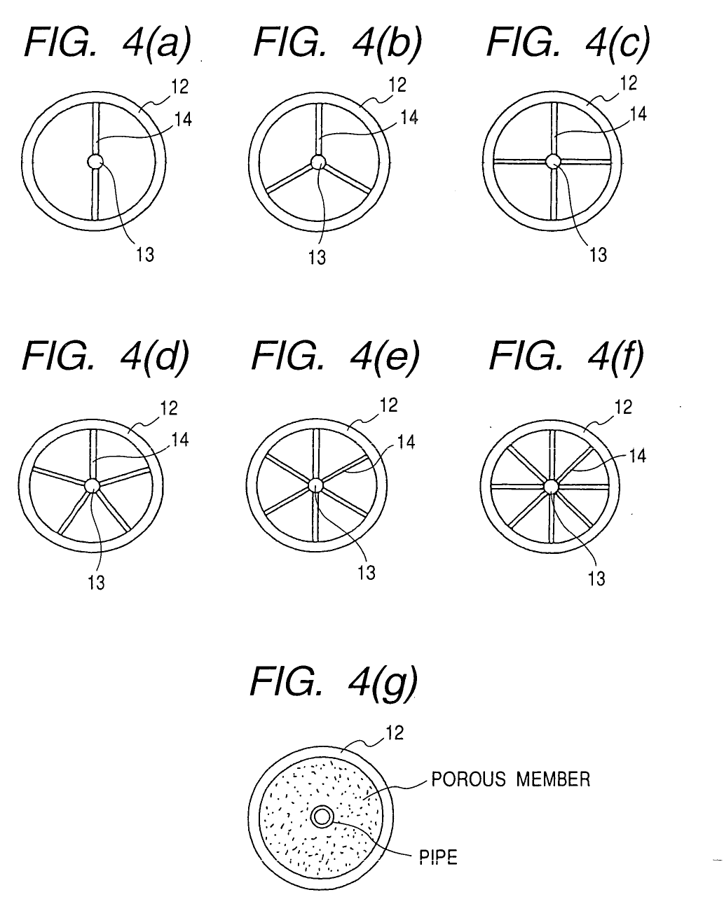

Specifically, about 2 to 8 radial holes are preferable as shown in FIGS. 4(a) to 4(f). If the number of radial holes is increased in excess of those numbers just mentioned, the operation and beneficial effects produced by the resultant roller resemble those of the conventional roller as shown in FIG. 4(g) Such should be avoided.

A diameter of each radial hole is determined depending on a viscosity of a coating material used.

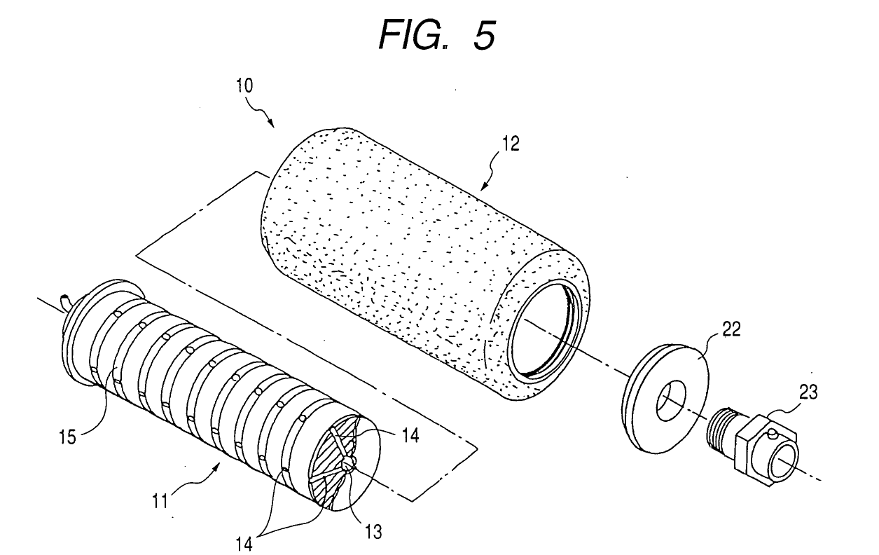

Further, in the first embodiment, grooves 15 (see FIG. 5) are formed at the outlets of the radial holes 14, each groove extending around the solid cylindrical body. With provision of the grooves, the coating material flowing from the radial holes are easy to spread in the circumferential direction while being guided by the circumferentially extending grooves. Accordingly, the coating material swiftly and uniformly spreads over the entire roller surface to thereby contribute to formation of a uniform coating.

A flange 16 is formed at one end of the solid cylindrical body 11, and a female screw 17 is formed at the center of the other end thereof.

The roller brush 12 includes a drum 18 made of a rigid material, such as synthetic resin or metal. Fibers made of synthetic resin are bonded or planted in the drum 18. A number of holes 19, which are located at the grooves 15, are formed in the drum 18, while passing through the latter.

The roller brush assembly 10 is assembled in the following manner. The roller brush 12 is fit into the solid cylindrical body 11 from the other end thereof in a state that a gasket 20 is attached to the flange 16 of the solid cylindrical body 11. Then, a disc 22 is engaged with the other end of the solid cylindrical body 11 with a gasket 21 interposed therebetween. A bolt 23 is screwed into a female screw 17 of the solid cylindrical body 11.

FIG. 5 is an exploded perspective view showing the roller brush assembly 10 shown in FIG. 1. The roller brush assembly 10 includes the solid cylindrical body 11 and the roller brush 12. It is assembled such that the disc 22 is engaged with the end of the roller brush 12, and the bolt 23 is screwed into the solid cylindrical body 11 (the assembling process will be described later). As illustrated, the radial holes 14 radially extend from the axial center hole 13, and the grooves 15 extend from the outlets of the radial holes 14 in the circumferential direction to make a round of the solid cylindrical body.

### Second Embodiment of the Invention

A second embodiment of the invention will be described.

The second embodiment relates to a way of feeding a coating material to the axial center hole 13 of the solid cylindrical body 11 including the coating pressure feed roller, and a way of supporting the solid cylindrical body 11.

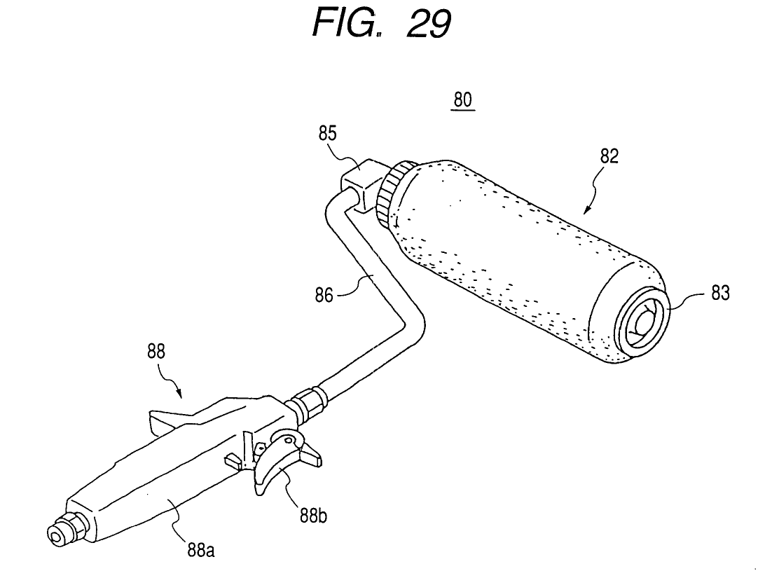

As described in connection with FIG. 29, in the conventional roller coating device, the coating material is fed to the roller from one end of the roller, and the roller is supported in a cantilever fashion. Accordingly, the conventional roller coating device suffers from the disadvantages as mentioned above. In the instant embodiment, coating-material press feeding pipes 24 (see FIG. 1) are connected to both ends of the axial center hole 13 of the solid cylindrical body 11. The coating pressure feed roller is rotatably supported at both ends by arms 31, and the arms 31 are couple together by a lower frame 32, whereby a support 30 is formed.

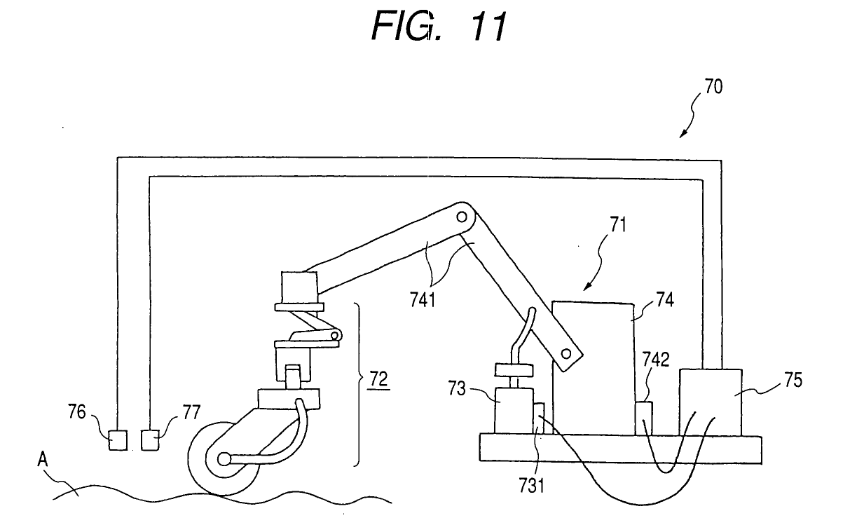

The coating-material press feeding pipes 24 are coupled to both ends of the solid cylindrical body 11, and the ends of the coating-material press feeding pipes 24 are connected to a pump (see reference numeral 73 in FIG. 11). The roller brush assembly 10 thus constructed receives the coating material from both ends of the axial center hole. The coating material supplied to the axial center hole 13 is fed to the annular grooves 15 by way of the radial holes 14, and is distributed through the grooves to the radial holes 14.

A known structure may be used for such a structure that the roller brush assembly 10 is rotatably supported by the arms 31, and the coating-material press feeding pipe 24 is connected to the axial center hole 13 of the solid cylindrical body 11.

Thus, in the instant embodiment, the coating material is supplied to both ends of the coating pressure feed roller, and the coating pressure feed roller is supported at both ends thereof. Therefore, a liquid pressure is uniform over the axial center hole passing through the axial center of the roller. Further, a pressing force applied to the coating pressure feed roller is uniform. As a result, the coating material is uniformly distributed to the entire roller.

### Third Embodiment of the Invention

A third embodiment of the invention will be described.

A coating device of the third embodiment, as shown in FIG. 1, includes a turnable support mechanism 40 for turning the support 30 which supports the roller brush assembly 10 in a direction of an arrow A, and a vertically movable support mechanism 50 for vertically moving the same in a direction of an arrow B.

The support 30 includes the two arms 31 and the lower frame 32 bridged between those arms. The two arms 31 rotatably support the roller brush assembly 10 therebetween. The support 30 is mounted to the turnable support mechanism 40, and the turnable support mechanism 40 is mounted to the vertically movable support mechanism 50.

The turnable support mechanism 40 is constructed such that a plate 41 extends on the upper surface of the lower frame 32 in parallel with the axis of the roller brush assembly 10. The plate is rotatably coupled to the intermediate frame 33 by means of a pin 42.

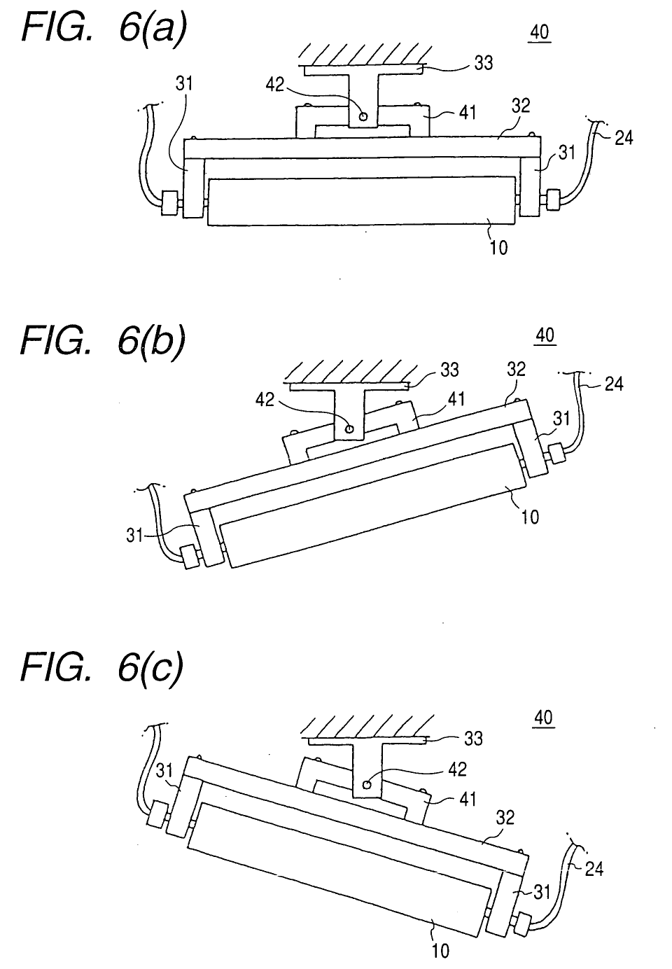

FIG. 6 is a diagram for explaining operation of a turnable support mechanism 40 in FIG. 5: FIG. 5(a) shows a state that the roller rolls on a flat surface; FIG. 6(b) shows a state that the roller rolls on a surface curved upward to the right; and FIG. 6(c) shows a state that the roller rolls on a surface curved downward to the left.

In FIG. 6(a), the roller brush assembly 10 rolls on a flat surface, and hence, the intermediate frame 33 takes a horizontal posture about the pin 42.

In FIG. 6(b), when the roller brush assembly 10 moves to a surface curved upward to the right, the intermediate frame 33 is turned about the pin 42. Accordingly, while the intermediate frame 33 keeps the horizontal posture, the roller brush assembly 10 located thereunder is allowed to roll on and along the surface curved upward to the right.

In FIG. 6(c), when the roller brush assembly 10 moves to the surface curved upward to the left, the intermediate frame 33 is turned about the pin 42 in the direction opposite to the direction in FIG. 6(b). Accordingly, while the intermediate frame 33 keeps a horizontal posture, the roller brush assembly 10 thereunder may roll on and along the surface curved upward to the left.

A part of the coating-material press feeding pipe 24 is made of a flexible material, and its length is sufficiently long. Therefore, even if the roller brush assembly 10 is turned, the coating-material press feeding pipe may follow a motion of the roller brush assembly 10.

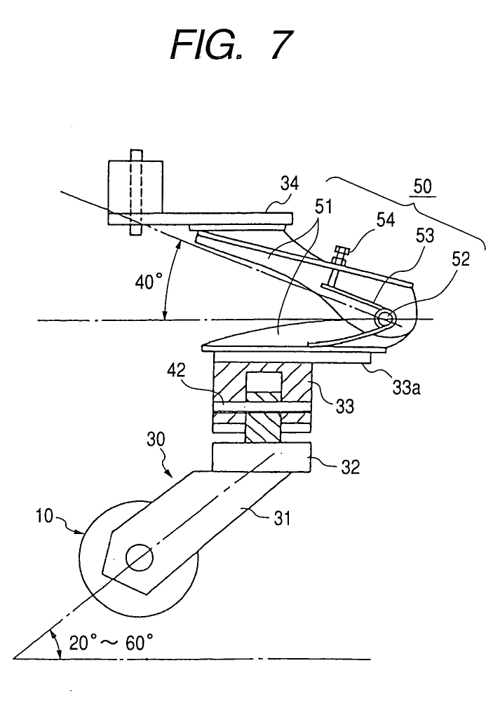

In the third embodiment, the support 30 further includes the vertically movable support mechanism 50. FIG. 7 shows the vertically movable support mechanism 50.

In FIG. 7, in the vertically movable support mechanism 50, two arms 51 which integrally supports the upper frame 34 at the free end is supported on a table 33a of the intermediate frame 33 by means of a pin 52. Those arms 51 are upwardly urged by a spring (a twisted compression spring in this instance) 53.

The vertically movable support mechanism 50 includes an adjusting screw 54 for adjusting an urging force of the spring 53, and the screw abuts on one end of the spring 53.

In the vertically movable support mechanism 50, a maximum opening angle of the arms 51 is set to be within approximately 20° to 60° by an angle regulating means (not shown). Our experiment showed that the angle range from approximately 20° to 60° allows a natural vertical motion of the support 30.

It is preferable that the arms 31 which rotatably support both ends of the roller brush assembly 10 is slanted at an angle within a range from approximately 20° to 60° with respect to the horizontal plane. This fact was also found by our experiment.

A weight applied to the roller is preferably within a range of 0.6 to 1.5 kgf (5.7 to 14.7N). If the pressing force is smaller than any value of the range of forces, a rolling performance of the roller deteriorates, an inclination of a configuration based on the curved surface deteriorates. Conversely, if the pressing force is larger than any value of the range of forces, the surface to be coated (car body in the case of the automobile coating) is deformed, a [symbol] of the roller deteriorates, and a film thickness of the coating surface increases at both ends of the roller.

The weight applied to the roller may be increased by adjusting the adjusting screw 54 to increase the opening angle.

It is evident that the vertically movable support mechanism 50 may be substituted by any other suitable mechanism, such as a pantograph mechanism.

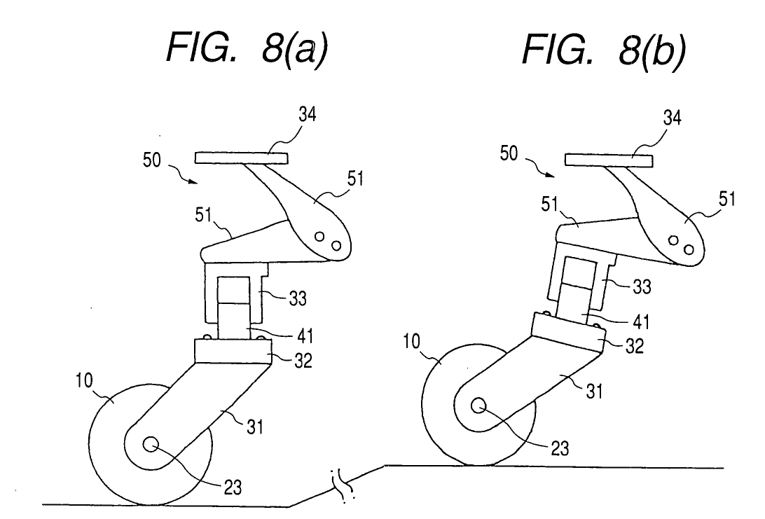

FIG. 8 is a diagram for explaining operations of the vertically movable support mechanism 50 of FIG. 7: FIG. 8(a) shows a state that the roller rolls on a low surface; and FIG. 8(b) shows a state that the roller rolls on a high surface.

In FIG. 8(a), the roller brush assembly 10 rolls on a low surface. Accordingly, in the vertically movable support mechanism 50, the opening angle of the arms 51 increases to allow the roller brush assembly 10 to move downward to the low surface. In FIG. 8(b), the roller brush assembly 10 rolls on a high surface, in the vertically movable support mechanism 50, the opening angle of the arms 51 decreases to allow the roller brush assembly 10 to retract to the high surface.

Thus, the third embodiment includes the turnable support mechanism 40 for turning the support 30 in the direction of an arrow A in FIG. 1, and the vertically movable support mechanism 50 for vertically moving the same in the direction of an arrow B. Therefore, the roller brush assembly 10 is always pressed against a curved surface having vertically and horizontally inclined slopes, from the right above.

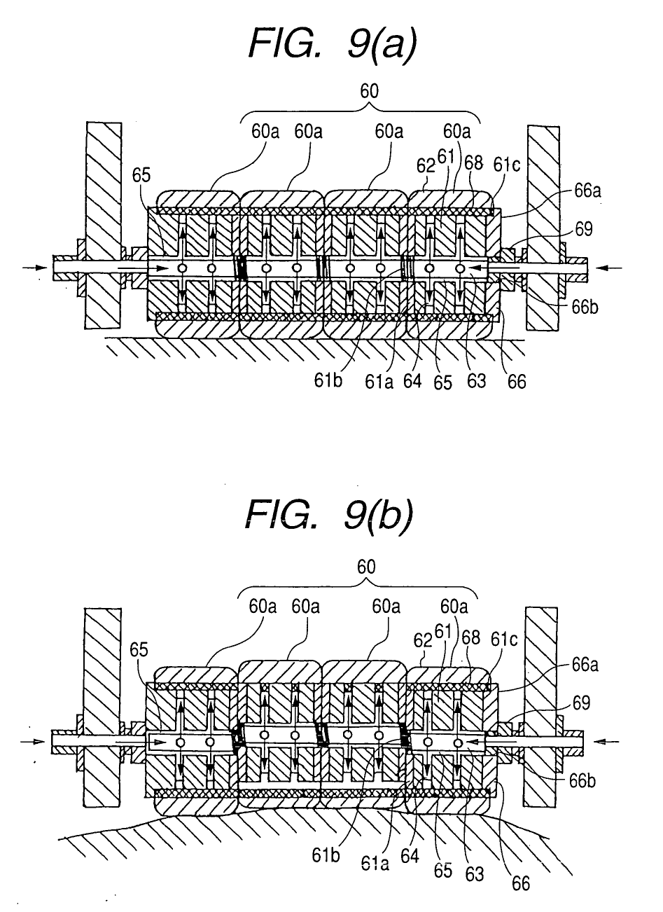

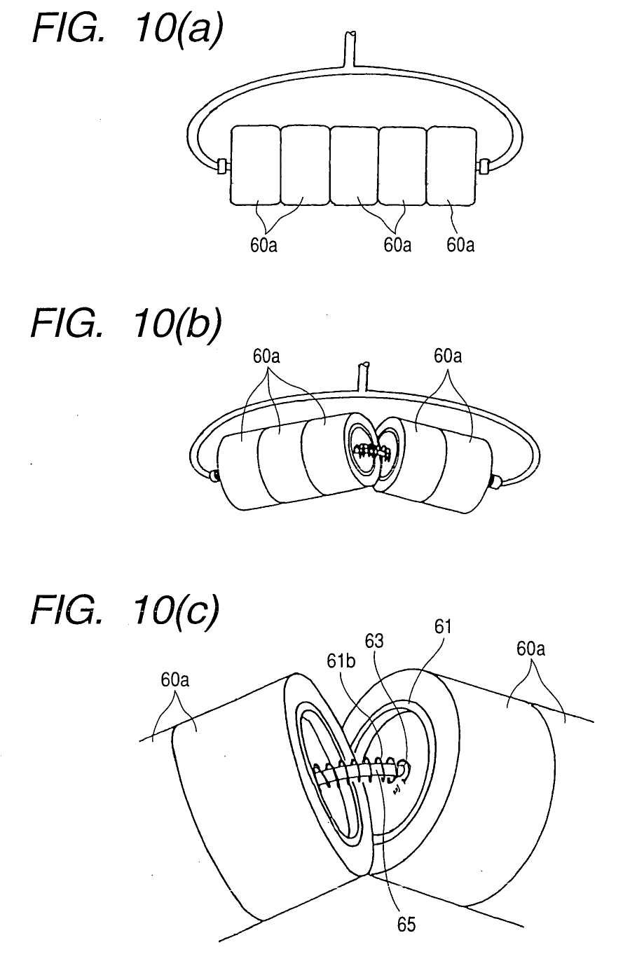

FIG. 9 is a diagram showing a roller which is effectively operable for the coating of a curved surface and a modification of the roller brush assembly of FIG. 2: FIG. 9(a) is a cross sectional view showing the coating of a flat surface, and FIG. 9(b) is a cross sectional view showing the coating of an irregular surface. FIG. 10 is a diagram showing an outward appearance of a roller brush assembly including five divided rollers: FIG. 10(a) is a view showing the roller brush assembly when it is a normal state; FIG. 10(b) is a view showing the roller brush assembly when the divided rollers are separated; and FIG. 10(c) is a partially enlarged view showing the roller brush assembly of FIG. 6(b).

As shown in FIG. 9, the roller brush assembly 60 is made up of a plurality of divided rollers 60a including a divided solid cylindrical body 61 and a roller brush 62 fit to the divided solid cylindrical body 61, a tension spring 61b for giving pulling forces to the adjacent divided rollers 60a, and a flexible tube passing through the axial center holes of the adjacently located divided rollers 60a.

The divided solid cylindrical body 61 is made of synthetic resin, metal or the like, and solid. The divided solid cylindrical body 61 has a solid structure which includes coating material feeding passages formed by an axial center hole 63 passing through the axial center thereof, and radial holes 64 radially extending from a plurality of positions of the axial center hole 63. Annular recesses 61a are provided in both side surfaces. Tension springs 61b are attached to the annular recesses 61a, so that the adjacent divided rollers 60a mutually pull. As seen from an enlarged view of FIG. 10(c), those divided rollers 60a may be separated from each other by applying external forces to them.

The radial holes 64 are a total of four holes which are radially extended from the axial center hole 63 while being angularly spaced by 90°. The number of the radial holes is not limited to four, and the diameter of each radial hole may be selected, as desired, depending on factors, such as a viscosity of the coating material, as a matter of course.

A single flexible Teflon tube 65 passes through those axial center holes 63 and the tension springs 61b. Within the axial center holes 63, the Teflon tube 65 is put to the axial center holes 63 in a close contact fashion such that the holes formed in the Teflon tube 65 are positioned at the radial holes 64 extending from the axial center holes 63.

By so constructed, the coating material is smoothly fed to the radial holes 64 of the divided rollers 60a, and the tension springs 61b are not soiled with the coating material.

Further, in the embodiment, grooves are formed at the outlets of the radial holes 64, each groove extending around the solid cylindrical body. With provision of the grooves, the coating material flowing from the radial holes are easy to spread in the circumferential direction while being guided by the circumferentially extending grooves. Accordingly, the coating material swiftly and uniformly spreads over the entire roller surface to thereby contribute to formation of a uniform coating.

A flange 66a is formed on the outer periphery of the outermost divided solid cylindrical body 61, and a disc 66 having a female screw 66b is formed in the inner periphery of the divided solid cylindrical body 61.

The roller brush 62 includes a drum 68 made of a rigid material, such as synthetic resin or metal. Fibers made of synthetic resin are bonded or planted in the drum 6. A number of holes, which are located at the grooves, are formed in the drum 6, while passing through the latter.

The roller brush assembly 60 is assembled in the following manner. The roller brush 62 is fit into the solid cylindrical body 61 from the other end thereof in a state that a gasket 61c is attached to the flange 66a of the divided solid cylindrical body 61. Then, a disc 66 is engaged with the other end of the divided solid cylindrical body 61 with a gasket 61c interposed therebetween. A bolt 69 is screwed into a female screw 66b of the divided solid cylindrical body 61.

To coat a flat surface, as shown in FIGS. 9 and 10(a), the divided rollers 60a are rotated while being aligned with an axial line and the coating material is fed to the roller from both ends thereof. This case is the same as of FIG. 2.

To coat the irregular surface, the divided rollers 60a, as shown in FIG. 9(b), are shifted from each other along an irregular surface, while resisting a friction force perpendicular to a tensile force of the tension springs 61b, and by the flexible Teflon tube 65. Therefore, the coating material is coated on the irregular surface.

If the roller brush assembly 60 of the division type is applied, in place of the roller brush assembly 10, to the second and third embodiments, the resultant beneficial effects are further increased, as a matter course.

### Fourth Embodiment of the Invention

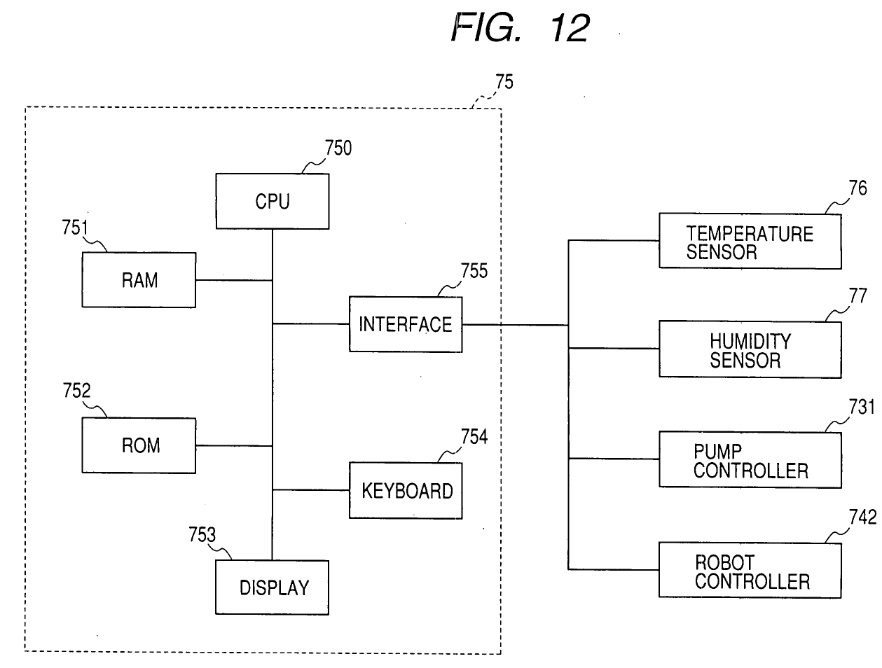

A fourth embodiment of the invention will be described with reference to FIGS. 11 and 12. The fourth embodiment relates to an automatic coating, and in the automatic coating, the curved-surface operable roller coating device according to the third embodiment is attached to the tip of a robot arm.

FIG. 11 is a diagram showing an automatic coating apparatus which is a fourth embodiment of the invention. FIG. 12 is a block diagram showing a central control unit in FIG. 11.

In FIG. 11, reference numeral 70 is an automatic coating apparatus; 71 is a coating robot; 72 is a curved-surface operable roller coating device attached to the tip of a movable part of the coating robot 71; 73 is a coating-material pressure feed pump; 731 is a pump control unit; and 74 is a robot body, which is a multiarticulate robot of the teaching playback type. The robot body 74 includes a movable part 741 operably coupled, and its robot operation is controlled by a robot control unit 742. The robot control unit 742 receives a control instruction from the central control unit 75, and controls the robot operation of the robot body 74. Reference numeral 76 is a temperature sensor for sensing temperature in a coating environment, and 77 is a humidity sensor 77 for sensing humidity in a coating environment. The temperature sensor 76 and the humidity sensor 77 sends sensing signals to a central control unit 75.

In FIG. 12, the central control unit 75 is made up of a CPU 750 for processing temperature/humidity data received, decoding the data in the RAM, and controlling an overall system of the automatic coating apparatus, such as pump control and robot control, a RAM 751 for storing data about environmental temperature and humidity, kind and viscosity of a coating material, pressure of the coating pressure feed pump, pressure of the coating material, and others, a ROM 752 for storing operation procedures in the CPU 750 a display device 753 for displaying current operation status, values entered by the keyboard, and others, a keyboard 754 for entering and changing data, and an interface 755 for transmitting and receiving signals to and from external devices. Examples of external devices are the temperature sensor 76 for sensing temperature in a coating environment, the humidity sensor 77 for sensing humidity in a coating environment, the pump control unit 731 and the robot control unit 742.

Next, operations of the automatic coating apparatus 70 will be described.

An operator enters coating conditions (e.g., a kind of a coating material to be used for coating an object to be coated and a thickness of a coating film to be formed on the object) by use of the keyboard. Sensing signals derived from the temperature sensor 76 and the humidity sensor 77 are sent to the central control unit 75. The central control unit 75 receives the coating conditions and sensing signals from the sensors, and computes, for satisfying the coating conditions, an optimum amount of coating material discharged from the pump, and optimum pressure and moving speed of the coating pressure feed roller in accordance with them, and resultantly sends control commands to the pump control unit 731 and the movable part 741. In accordance with the control commands, the pump control unit 731 controls the coating-material pressure feed pump 73 to adjust an amount of coating material to be pressure fed, and the movable part 741 controls the robot body 74 to adjust the pressing force and moving speed for the roller.

The coating material supplied to a surface of the coating pressure feed roller moves down to a lower part of the coating pressure feed roller by gravity, when a viscosity value of the coating material falls within a range of some values of viscosity. To cope with this, it is preferable to reciprocatively move, several times, the coating pressure feed roller on another contact surface before the coating process starts, to thereby uniformly distribute the coating material gathered at the lower part of the roller to the entire roller surface.

By so doing, the movable part 741 of the robot body 74 moves, and hence, the curved-surface operable roller coating device 72 attached to the tip of the movable part also moves. At this time, even if the coating surface is irregular, the curved-surface operable roller coating device 72 of the invention follows, in motion, an irregular surface variation of the irregular surface, thereby gaining a coating film of a uniform thickness.

As described above, the instant embodiment can produce a coating film which is much more uniform in thickness than by the conventional automatic spray type coating device.

Only a portion of the surface of the coated object on which the roller has rolled is coated. Therefore, there is no chance that the dust is formed as in the conventional spray type coating device.

Further, there is no need that the robot body 74 checks an irregularity on the coated surface every time the coating is carried out, and moves the movable part 741 vertically along an irregular surface variation of the irregular surface. It suffices that the roller merely moves in the horizontal direction. Accordingly, the control is considerably simplified. This is an advantageous feature.

The same thing is true for a case where a surface to be coated has an inclination inclined in horizontal directions. Accordingly, it suffices to move the roller in the horizontal direction, and hence, the control is remarkably simplified.

As describe above, according to the present invention, there is no need of the manual coating work using the roller. Accordingly, the coating material is uniformly applied to the entire roller, and hence, nonuniformity of the coating film thickness is not produced. There is no need of repeating such a process that the coating material is applied to the roller several times, and then the coating material is infiltrated again into the roller. This advantageously results in reducing labor cost and working hours, and the coating booth.

Further, the automatic coating apparatus of the roller type according to the present invention may be applied to the coated objects which have been coated by use of the roller, without any limitation. Specific examples of those objects are objects concerning vehicles and construction, ships, furniture, and objects concerning roads.

In a case where the vehicular object is the car body, the invention may be applied to not only hood, roof and trunk, but also vertically installed components, such as bumper, fender, and doors, by using protection material or anti-scratch material.

The coating material used by the invention is not limited to the coating material which is conventionally used by the known roller coating process, but may be an aqueous coating material an organic solvent coating material and the like.

Embodiments of the second invention will be described with reference to the related drawings.

Pre-stages of forming a protecting film for protecting a coating film of an automobile is as follows: 1) To clean a car by water washing; 2) to drain the washing water; 3) to mask the car body except a portion thereof on which a protecting film is to be formed; 4) to coat a protecting film; 5) to perform a correction and finishing coating if necessary; and 6) to dry the coated car. If a surface of the automobile is not soiled, the stages 1) to 3) may be omitted.

1) An automobile W on which a protecting film is formed is subjected to a washing stage. In the stage, the car body is entirely washed by a car washing machine of the shower type which uses a rotary brush, to thereby remove rainwater, dust and the like sticking to the surface of the coating film. In the cold season, water drops attached to the coating film surface is frozen to possibly damage the coating film surface. To avoid this, warm water of 30 to 50° C. is used for washing.

2) In the washing water draining stage following the washing stage, washing water left on the surface of the coating film of the automobile W, which is washed in the washing stage, is removed by blowing hot air of about 30 to 70° C. onto the coating film surface. The warm water used in the washing stage and the hot air used in the washing water draining stage make good the coating of an aqueous coating material, which is carried out in a coating stage as a post stage. Therefore, a surface temperature of the automobile is appropriately kept. The surface temperature of the automobile is 15° C. or higher, preferably 20 to 30° C. in consideration of the film formability of the coating material.

3) In the next masking stage, to mark off the boundary between a coating area to be coated with an aqueous coating material and a non-coating area, a masking tape is applied to the surface of the automobile W having the washing water drained and dried in the washing water draining stage. The intake duct opened at the engine hood, and non-coating parts, e.g., resin parts, located within the coating area, are covered with a cover or the like.

4) In the coating stage, the coating area defined by the masking tape in the masking stage is coated with an aqueous coating material mainly containing acrylate emulsion (e.g., “Wrap Guard L”, manufactured by Kansai Paint corporation) by using the roller brush coating device according to the second invention.

5) In the next finishing coating stage, which may be carried out if necessary, the masking tape applied in the masking stage is peeled off, and the cover is removed. In a finishing coating, small uncoated portions in the coating area are manually coated with an aqueous coating material by using a brush or a small roller brush. The masking stage, the coating stage, and the finishing coating stage are carried out within the coating booth.

6) In the subsequent drying stage, the coated car is placed in an IR drying furnace, and irradiated with infrared rays for about 30 to 90 seconds, thereby enhancing the drying of the coated aqueous coating material inclusive of the interior thereof. Subsequently, the aqueous coating material is dried by uniformly heating the entire coated car body by using hot air drying furnace or by using only the hot air drying furnace, thereby forming a protecting film. Where the hot air drying furnace is used, it is preferable to dry the coating material for about 210 minutes under conditions that a drying temperature is 50 to 100° C. and a hot air velocity is 0.5 to 8 m/sec., to secure a satisfactory film formability of the aqueous coating material and to protect attached components such as various kinds of electric components.

The above-mentioned stages may be substituted by an in-line stages. In this case, after the coating stage (intermediate and finish coating) of the automobile ends and an inspection stage ends, the car body is coated with the protecting coating material, and dried, and thereafter components such as meters are attached to the car, whereby a finished car is presented.

The “coating material” used here is a coating material for forming a coating film for protecting the coating of the car body. A viscosity of the coating material is higher than that of normal color coating material. Accordingly, it is difficult to perform such a coating for the formation of the protecting film by use of a conventional spray type automatic coating apparatus. For this reason, the manual work using the coating roller is used for the coating.

The automatic coating roller according to the first invention enables the stages of forming a protecting film of high viscosity to be automated.

### First Embodiment of the Second Invention

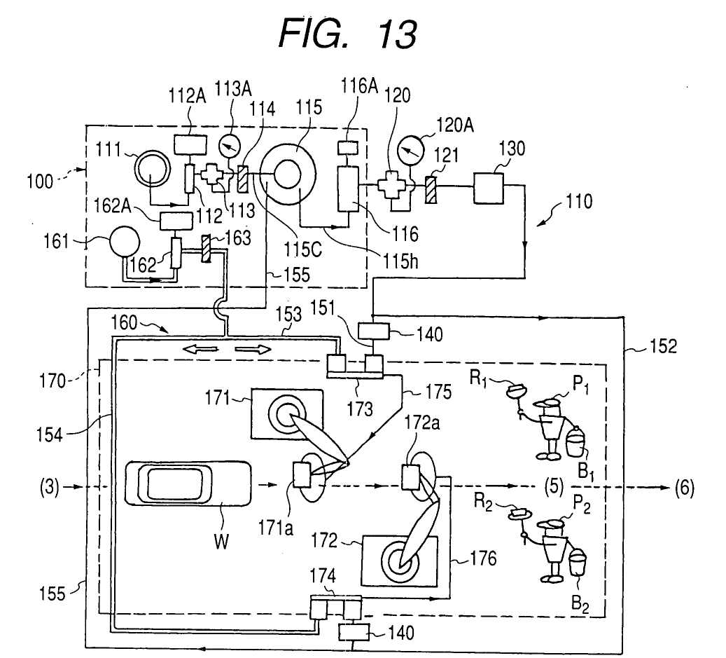

FIG. 13 is a diagram showing an arrangement of a automated coating apparatus which is a first embodiment of a second invention.

A full automatization of the coating stage 4) of those stages 1) to 6) is illustrated in FIG. 13. In FIG. 13, a coating material preparing chamber 100 contains a coating material feeding system 110 for supplying a coating material to the coating roller and a detergent feeding system 160 for feeding a detergent to the coating roller for cleaning the coating roller.

The coating material feeding system 110 will first be described. The term “coating material” used here is a coating material of high viscosity for coating film protection.

Reference numeral 111 is a coating material can; 112 is a pump; 112A is a pump drive motor; 113 is a regulator; 113A is a scale gauge; 114 is a solution filter for removing foreign matters mixed into the coating material; 115 is a coating material tank; 116 is a pump; and 116A is a pump drive motor. An aqueous coating material for film forming contained in the coating material can 111 is sucked by the pump 112; it leaves the coating material can 111; its pressure is controlled by the regulator 113; and impurity contained therein is filtered out by the solution filter 114; and it enters the coating material tank 115.

The regulator 120, the scale gauge 120A, the solution filter 121 for filtering out foreign matters mixed into the coating material, a heat exchanger 130 for adjusting temperature of the coating material being transported, and a liquid quantity stabilizer 140 are located outside the coating material preparing chamber 100. The coating material flowing out of the liquid quantity stabilizer 140 branches into two pipings 151 and 152 for feeding the coating material to a second automatic coating apparatus in a coating booth. After the coating material passes through the two automatic coating apparatuses, the remaining coating material passes through a return piping 155 and returns to the coating material tank 115.

The detergent feeding system 160 will now be described.

Reference numeral 161 is a detergent drum; 162 is a pump; 162A is a pump drive motor; and a detergent filter 163 is a detergent filter. A detergent flowing out of the detergent filter 163 branches into two pipings 153 and 154, and is fed to the two automatic coating apparatuses within the coating booth.

Reference numeral 170 is a coating booth.

Two coating robots 171 and 172 are provided in the coating booth 170. Reference numerals 171a and 172a indicate both-end coating pressure feed rollers which are constructed according to the second invention, and effectively operable for coating a curved surface. Those rollers are attached to the tips of the arms of the coating robots 171 and 172. The output lets of CCVs (color change valves) 173 and 174, provided at the entrance of the coating booth are connected to pipings 175 and 176. The CCVs 173 and 174, unlike a needle valve, permits and prohibits the supply of one kind of coating material and selects one of plural coating liquids by air switching and discharges the selected one. In this instance, a coating material piping 151 and a detergent piping 153 are connected to the inlet of the CCV 173. The CCV 173 switches the piping from one piping to the other piping by an air switching every time the necessity occurs. Similarly, the coating material piping 152 and the detergent piping 153 are connected to the inlet of the CCV 174, and switches the piping from one piping to the other piping by an air switching every time the necessity occurs.

The CCVs 173 and 174 are provided at the entrance of the coating booth 170. If the CCVs are provided near the arms of the coating robots 171 and 172, the coating pressure feed rollers 171a and 172a can be washed in the same level with less consumption of the detergent.

In FIG. 13, W indicates an object to be coated, such as an automobile, is transported into the coating booth 170 after it underwent the inspection stage line and the masking stage 3). The object is coated to have a protecting film in the coating booth 170, and is subjected to the correction and finishing coating stage if necessary. P1 and P2 are workers who manually perform a pre-correction coating and a post-correction coating (finishing coating). The workers take the roller brushes R1 and R2 and coating cans B1 and B2 in their hands, and manually coat portions which could not be coated in the automatic coating process. The automobile W is finishing coated if necessary, and transported from the coating booth 170 to the next drying stage 6).

The components forming the automated coating apparatus will be described in detail.

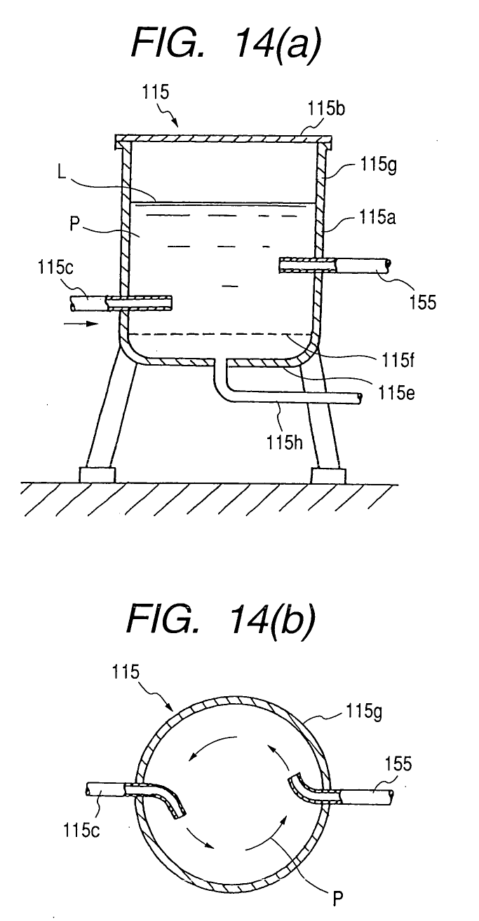

FIG. 14 is a diagram for explaining a coating material tank used in the second invention: and FIG. 14(a) is a longitudinal sectional view showing the coating material tank; and FIG. 14(b) is a transverse cross sectional view showing the same. The coating material tank 115 is capable of storing a coating material of high quality which is free from the formation of a skinning on the coating liquid surface, and may be reduced in size and simplified in construction. The coating material tank 115 includes a tank body 115a storing an aqueous coating material, a lid 115b for hermetically sealing the tank body, a replenishing piping 115c for feeding an aqueous coating material P into an aqueous coating material P stored in the tank body 115a, a feeding piping 115h, and a return piping 155. The tank body 115a is a bottomed cylindrical tank of which the upper side is opened, is coated with a material having good water repellent, e.g., Teflon. A screen mesh 115f is spread near the bottom 115e of the tank body 115a. The lid 115b is fixed to the upper end of a side wall 115g of the tank body 115a and closes the tank body 115a.

The replenishing piping 115c and the return piping 155 pass through the side wall 115g at different height positions in the medium height of the side wall 115g of the tank body 115a. The fore ends of those pipings are bent in the circumferential direction within the tank body 115a as shown in FIG. 14(b). Accordingly, the aqueous coating material P that flows from the fore ends of the replenishing piping 115c and the return piping 155 into the aqueous coating material, forms an eddy to gently stir the aqueous coating material P stored in the tank body 115a without dragging air thereinto. The discharging piping 115h is connected to the bottom 115e of the tank body 115a. The coating material is supplied to the coating device in the coating booth 170 by the pump 116, and is applied to the coating film on the automobile by the robots and the rollers of the second invention.

The coating material left over in the coating booth 170 is returned to the coating material tank 115 by way of the return piping 155. When the coating material is consumed and a liquid level L of the aqueous coating material P in the coating material tank 115 descends to a predetermined lower limit value, the pump 112 operates and the aqueous coating material P is supplied from the coating material can 111 to the coating material tank 115 via the replenishing piping 115c. When the liquid level L reaches a predetermined upper limit value, the supplying of the coating material for replenishment stops.

The liquid level L of the aqueous coating material P in the coating material tank 115 is caused to intermittently vary between the upper limit value and the lower limit value. The upper end of the tank body 115a is hermetically closed by the lid 115b. Therefore, it never happens that a space located above the aqueous coating material P within the coating material tank 115 is, excessively dried. Humidity in the space is put in a humidified condition where the humidity is 100% by the evaporation of water content of the aqueous coating material P. Accordingly, it is avoided that the coating material left sticking to the inner surface of the side wall 115g, which is located above the liquid level L, and the coating material at the liquid level L are dried. It is avoided that the aqueous coating material P on the inner surface of the side wall 115g and at the liquid level L is half-solidified, viz., formation of the skinning is avoided.

During the coating work, the aqueous coating material P in the coating material tank 115 is ceaselessly and gently stirred by the coating material flowing thereinto from the fore end of the return piping 155. With the stirring, it is prevented that the pigment contained in the coating material settles down and coagulates, viz., a called caking phenomenon occurs.

Further, the fore ends of the replenishing piping 115c and the return piping 155 are projected into the aqueous coating material P within the tank body 115a. With this feature, there is no chance of dragging bubbles from the air into the coating material tank.

Additionally, there is no need of using a separate stirring pump, and hence, the cost to manufacture is low and there is no fear of dragging bubbles from the air into coating material tank.

Thus, in the coating material tank 115 thus constructed, the upper part of the tank body 115a storing the aqueous coating material P is sealingly closed with the lid 115b. The space in the upper part within the tank body 115a is put in a humidified condition by evaporation of the water content in the aqueous coating material P. The aqueous coating material P flowing from the replenishing piping 115c and the return piping 155 into the coating material tank 1 stirs the aqueous coating material P within the coating material tank 1 to thereby prevent occurrence of the caking by the sedimentation of the pigment. Accordingly, the coating material tank stores the coating material which is free from formation of the skinning and the caking. Further, there is no need of using the overflow bath and the stirring pump, and hence, the tank is simplified in construction and reduced in size.

An example of the pump 112 used in the second invention will be given.

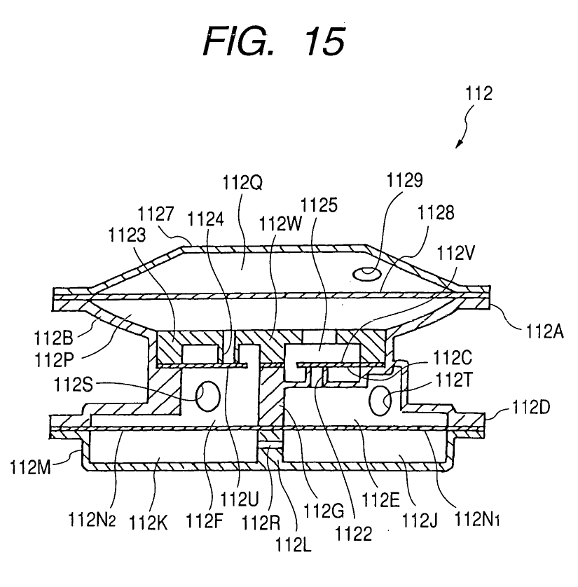

FIG. 15 is a longitudinal sectional view showing the pump 112 used in the second invention.

In the figure, reference numeral 12 designates a pump. A pump chamber incurvated part 112B is incurvated downward from an upper collar 112H of the pump. A latching step 112C is formed on the bottom of the pump chamber incurvated part 112B. An in-flow passage recess 112E and a discharge passage recess 112F are directed toward a lower collar 112D of the pump 112, while being partitioned by a partitioning wall 112G. A suction valve seat 1122 is formed ranging from the in-flow passage recess 112E to the latching step 112C. An upstream part of the suction valve seat 1122 is opened to the in-flow passage recess 112E, and a downstream part thereof is opened to the latching step 112C.

Reference numeral 1123 designates a valve seat body fixed onto the latching step 112C. A suction-side check-valve receiving recess 1125 and a discharge valve seat 1124, which face onto the suction valve seat 1122, are partitioned by a partitioning wall 112W. An upstream part of the pump 112 is opened to the pump chamber incurvated part 112B, and its downstream part is opened to the latching step 112C.

A discharge side check valve 112U and a suction side check valve 112V are fixedly provided while being firmly held between the valve seat body 1123 and the latching step 112C of the pump 112. The suction side check valve 112V is firmly held at the right end, and faces onto the suction valve seat 1122. The discharge side check valve 112U is firmly held at the left end and faces onto the discharge valve seat 1124.

A pump cover 1127 is located on the upper collar 112H of the pump 112, and a pump diaphragm 1128 is firmly held between the upper collar 112H and the pump cover 1127.

As described above, the lower surface of the pump diaphragm 1128 and the pump chamber incurvated part 112B define a pump chamber 112P. An upper surface of the pump diaphragm 1128 and a pump cover 1127 define a pulsating pressure chamber 112Q. A pulsating pressure guide passage 1129 is opened to the pulsating pressure chamber 112Q.

A surge tank cover 112M is located on a lower collar 112D of the pump 112. For the surge tank cover 112M, a first recess 112J facing onto the in-flow passage recess 112E and a second recess 112K facing onto the discharge passage recess 112F are partitioned by a partitioning wall 112L.

A surge diaphragm 112N is firmly held between the lower collar 112D and the surge tank cover 112M. A suction side surge diaphragm 112N1 is disposed between the in-flow passage recess 112E and the first recess 112J. A discharge side surge diaphragm 112N2 is disposed between the discharge passage recess 112F and the second recess 112K. With such a structure, the suction side surge diaphragm 112N1 and the first recess 112J define a suction side surge tank, and the discharge side surge diaphragm 112N2 and the second recess 112K define a discharge side surge tank. The suction side surge tank and the discharge side surge tank are partitioned by a partitioning wall 112L. The partitioning wall 112L includes a communication passage 112R formed therein which communicatively interconnects the suction side surge tank 112J and the discharge side surge tank 112K.

The discharge passage recess 112F of the pump 112 is closed by the discharge side surge diaphragm 112N2 to form a discharge passage 112S. The in-flow passage recess 112E is closed by the suction side surge diaphragm 112N1 to form a suction passage 112T. The discharge passage 112S is connected to the coating material tank 115 (FIG. 13), and the suction passage 112T is connected to the coating material can 111 (FIG. 13).

Operations of the pump 112 will be described.

When a negative pressure is introduced into the pulsating pressure chamber 112Q via a pulsating pressure guide passage 1129 with the aid of the pump drive motor 112A (FIG. 13) or the like, the pump diaphragm 1128 displaces toward a pulsating pressure chamber Q to increase a chamber volume of the pump chamber 112P and to decrease a pressure in the aqueous coating material P. In turn, the discharge side check valve 112U closes the discharge valve seat 1124, while the suction side check valve 112V opens the suction valve seat 1122. Accordingly, the coating material in the coating material can 111 (FIG. 13) is sucked into the pump chamber 112P via the suction valve seat 1122.

A positive pressure is introduced into the pulsating pressure chamber 112Q via the pulsating pressure guide passage 1129. In turn the pump diaphragm 1128 displaces toward the pump chamber 112P, a volume of the pump chamber 112P decreases, and a pressure within the pump chamber 112P increases. As a result, the discharge side check valve 112U opens the discharge valve seat 1124, and the suction side check valve 112V closes the suction valve seat 1122.

The coating material stored in the pump chamber 112P is discharged through the discharge valve seat 1124 and the discharge passage 112S.

When a pulsating pressure is continuously introduced from the pulsating pressure guide passage 1129 into the pulsating pressure chamber 112Q, the pump diaphragm 1128 is reciprocatively displaced in a continuous manner, and hence, a pressure increased coating material is continuously supplied.

In a discharge stroke of the pump 112, the pressure increased coating material is supplied from the pump chamber 112P into the discharge passage 112S. In turn, the discharge side surge diaphragm 112N2 disposed facing the discharge passage 112S displaces toward the second recess 112K upon receipt of the pressure, and a pressure in the second recess 112K is increased. And, the increased pressured is introduced into the first recess 112J via the communication passage 112R formed in the partitioning wall 112L to apply a pressing force to the suction side surge diaphragm 112N1, and to accumulate a pressing force toward the suction passage 112T in the suction side surge diaphragm 112N1. This is due to the fact that a compressive force is sealed in the surge tanks 112J and 112K.

Then, the pump enters into a suction stroke. The suction valve seat 1122 is opened by the suction side check valve 112V, and the coating material is sucked from the suction passage 112T and fed into the pump chamber 112P. At this time, the suction side surge diaphragm 112N1 in which a pressing force toward the suction passage 112T is accumulated in the discharge stroke, is displaced to the suction passage 112T at a dash, and pressure feeds the coating material from the suction passage 112T to the pump chamber 112P.

As described above, in the pump 112 used in the second invention, the pump chamber 112P receives the coating material that is caused to flow by the negative pressure basis suction by the pump chamber 112P caused by the displacement of the pump diaphragm 1128, and additionally the coating material that is caused to flow by the pressure feeding action by the displacement of the suction side surge diaphragm 112N1. Therefore, a large amount of coating material flows into the pump chamber 112P when comparing with the conventional case.

Then, the pump chamber 112P enters into a discharge stroke. In this stroke, the coating material stored in the pump chamber 112P is discharged into the discharge passage 112S through the discharge valve seat 1124. Therefore, the amount of discharging coating material is greatly increased.

While in the instance mentioned above, the diaphragm pump capable of feeding a large amount of coating liquid is used, the pump is not limited to such a pump in the second invention, but any of the other types of pumps may be used. Examples of such are: a plunger pump in which the upper limit value of the coating liquid transporting amount is large to thereby enable a high speed coating (e.g., JP-A-2001-079812, JP-A-2001-193592, JP-A-2001-090676); a gear pump having a feature of accurately transporting a fixed amount of coating material, and another feature that when trouble occurs or maintenance is needed, its replacing work is extremely simple and consumes short time (JP-A-2002-005041, JP-A-11-244767, and JP-A-11-000589); a rotary pump featured in that no coating material leakage occurs, the service life is long, and the operability is good (JP-A-07-324684); and a Mono pump which imparts less limitation to layout, and is capable of stably transporting a coating liquid through a long passage (JP-A-10-070972, JP-A-2002-273556, and JP-A-2001-149838).

A combination of the coating material supply by the pump 116 in FIG. 13 and the gun tip vicinity may be used. In this case, a further exact quantitative is required.

Those may be used in the types of pumps mentioned above.

Description of the pump 112 provided for the coating material can 111 has been made. The same pump may be used for the pump 116 for the coating material tank 115, and the pump 162 for the detergent drum 161. In this case, of those pumps, another pump may be used or those pumps by making the best use of the features of those pumps. A combination of those pumps may be used.

In the instance mentioned above, the pump is used for transporting the coating material of the coating material tank 115 and the coating material can 111. For the energy saving, it is useful to use the self-weight by gravity or a pressure by applying pressure to the upper side of the tank for transporting the coating material.

Further, the pump 112 for the coating material can 111 may be omitted. In this case, one pump 116 for the coating material tank 115 is used also for transporting the coating material from the coating material can 111 to the coating material tank 115.

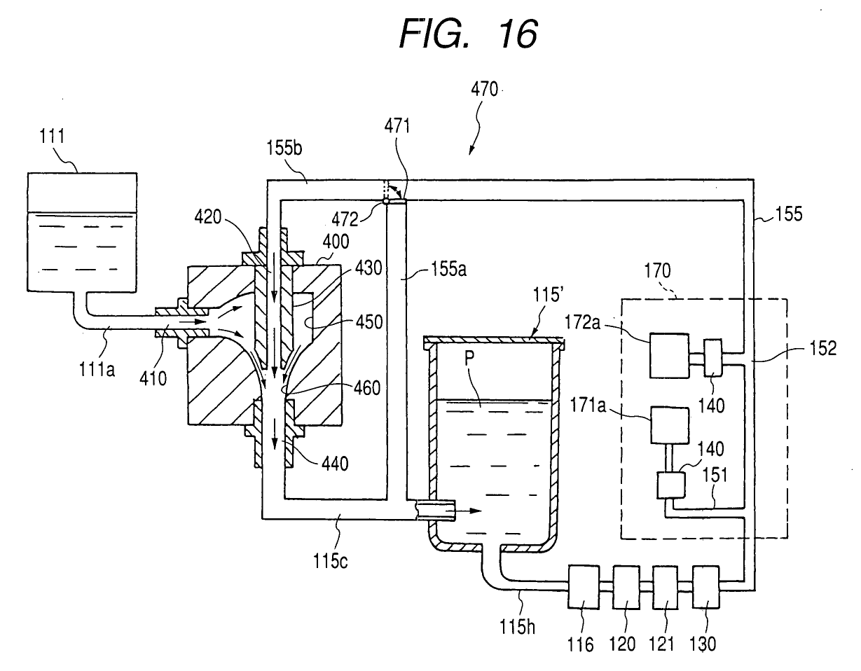

FIG. 16 is a diagram showing an energy-saving coating material cycling system in which one pump is used for executing the functions of the two pumps. The energy-saving coating material cycling system includes a coating material tank 115′ installed near the coating booth, a pump 116, a regulator 120, a solution filter 121 for filtering out foreign matters entering the coating material, a heat exchanger 130 for adjusting temperature of the coating material being transported, pipings 151 and 152 connecting to the coating devices in the coating booth 170, and a return piping 155. The return piping 155 branches out into pipings 155a and 155b at a position near the coating material tank 115′, and the piping 155a is directly connected to the replenishing piping 115c, and the piping 155b is connected to the replenishing piping 115c via an ejector pump 400. A switch valve 470 is provided at the branching point of the pipings 155a and 155b. The switch valve 470 includes a valve 471 and a support shaft 472. The valve 471 turns to the piping 155a or 155b about the support shaft 472. When the valve 471 is turned to the piping 155a, the piping 155b is opened. When it is turned to the piping 155b, the piping 155a is opened.

The fore end of the replenishing piping 115c is projected into the aqueous coating material P in the coating material tank 115′. As shown in FIG. 14(b), the replenishing piping 115c is bent along the side wall in the circumferential direction within the coating material tank 115′. Accordingly, the aqueous coating material P that flows into the aqueous coating material from the fore end of the return piping 155, forms an eddy to gently stir the aqueous coating material P stored in the tank body without dragging air thereinto. Accordingly, the stirring of the coating material depends only on the kinetic energy of the transporting coating material from the replenishing piping 115c.

The feeding piping 115h that is extended from the bottom of the coating material tank 115′ enters the coating booth 170 through the pump 116 and the like, branches into the pipings 151 and 152 connecting to the coating pressure feed rollers 171a and 172a in the coating booth. The return piping 155 for the remaining coating material branches into the pipings 155a and 155b. The piping 155b extends through the ejector pump 400 and returns to the coating material tank 115′.

The ejector pump 400 is incorporated into the piping 155b as one of the pipings of the return piping 155, and its suction port 410 is connected to the coating material can 111. The ejector pump includes an inlet 420 for receiving the coating material from the piping 155b, and an outlet 440 from which the coating material flows out. Of the suction port 410, the suction port 410 and the outlet 440 communicate with the pump chamber 450. The fore end of the in-flow piping 430 extending from the inlet 420 fronts on a funnel inner surface 460 formed on the wall of the pump chamber 450.

Accordingly, when the coating material flows from the piping 155b into the inlet 420, flows through the in-flow piping 430, and flows out from the outlet 440, a negative pressure occurs in the vicinity of the funnel inner surface 460. The coating material in a connection pipe line 111a, viz., the coating material in the solid cylindrical body 11, is sucked into the pump chamber 450 through the suction port 410. Both the coating materials flow out from the outlet 440 to the replenishing piping 115c, while being mixed, and finally fed to the coating material tank 115′.

In a normal operation, the valve 471 of the switch valve 470 is turned from the pipe 155a to the piping 155b about the support shaft 472. Accordingly, in this case, the pump 116 operates to feed the coating material to the coating booth 170 where the coating material is consumed. The remaining coating material flows from the return piping 155 and flows through the piping 155a and replenishing piping 115c, and is finally collected into the coating material tank 115′.

With progress of the operation, the amount of the coating material in the coating material tank 115′ decreases, and when a liquid level sensor (not shown) detects that the liquid level descends to be below a predetermined liquid level, the valve 471 of the switch valve 470 is turned from the piping 155b to the piping 155a about the support shaft 472. As a result, the piping 155a is closed, and the piping 155b is opened, so that the coating material flows from the return piping 155 into the ejector pump 400.

In the ejector pump 400, the coating material in the coating material can 111 is sucked into the ejector pump 400 via the connection pipe line 111a by the action of the ejector pump 400. Thereafter, both the coating materials are mixed and introduced into the coating material tank 115′. Thus, the coating material may easily be transported from the coating material can 111 to the coating material tank 115′ without using another pump.

Further, use of the ejector pump 400 considerably reduces a space required for the coating material transportation.

An additional advantage is that little electric energy is required for the operation of the ejector pump 400, and this fact contributes to energy saving, and the cost to operation is remarkably reduced.

An example of the filter used here will be described.

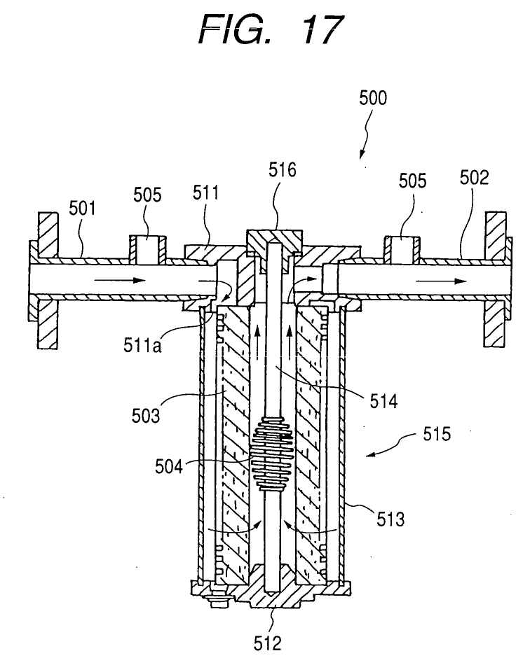

FIG. 17 shows a coating material filter which makes it hard for a sedimentary material in the coating material to precipitate onto the bottom thereof. As shown in FIG. 17, in a coating material filter 500, ahead 511 is provided with joints 501 and 502 on both sides thereof. Those joints are connected to a coating material feeding passage. A shell 513 includes a bottom plate cover 512 below the head 511. The shell 513 is fixed to a filter housing 515 with the aid of a rod 514. A hollow filter cartridge 503 is disposed within the filter housing 515. The coating material enters the coating material filter through an inlet nozzle 511a of the head 511, which communicates with the joint 501 at the entrance. Then, the coating material enters a filter cartridge 503 from its outer periphery, moves toward the center of the filter cartridge, and leaves the same. At this time, the filter cartridge filters out the foreign material of the coating material. Thereafter, the coating material moves upward in the hollow space of the filter cartridge 503, and is pressure fed from the joint 502 near the outlet to the coating material supplying passage.

Reference numeral 504 is a guide spring for setting the filter cartridge 503 at a predetermined position within the shell 513. Reference numeral 505 designates connection parts for connecting to various types of measuring gauges. In the coating material filter 500 thus constructed, when the filter cartridge 503 is replaced with another cartridge, a nut 516 provided at the tip of the rod 514 is loosened, the shell 513 is removed from the head 511, and the filter cartridge 503 is replaced with another cartridge.

Thus, when the solution is supplied, the filter body is positioned in the upper part in the solution supplying side. Therefore, there is no chance that the sedimentary material of large gravity within the coating material passing through the filter body precipitates and accumulates in the filter body.

The heat exchanger 130 for controlling temperature of the coating material will be described.

A distance from the coating material preparing chamber 100 to the coating booth 170 is relatively long. In a winter season, the piping is cold, so that when the coating material reaches the coating booth 170, temperature of the coating material is also low. In this state, the viscosity of the coating material becomes high. When under the blazing sun of summer, the temperature of the coating material is excessively high, a drying velocity of the coating material is excessively high. This is also undesirable.

To keep the liquid temperature of the coating material at an appropriate temperature, the heat exchanger 130 may be provided in the middle of the transporting route of the coating material. With provision of the heat exchanger, the coating work can stably be performed through all seasons.

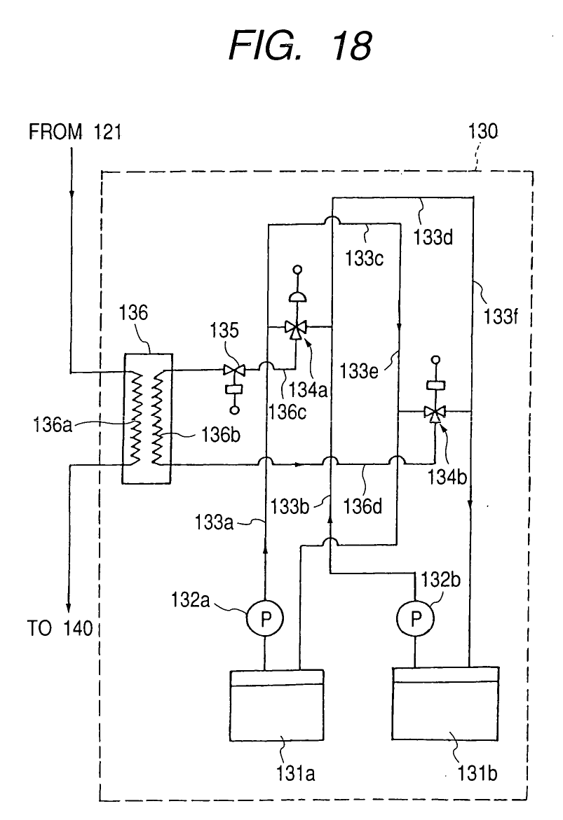

A heat exchanger described in the Japanese Patent No. 3120995 may be incorporated, as the heat exchanger 130, into the roller coating device. FIG. 18 is a diagram showing a heat exchanger used in the second invention.

In FIG. 18, the coating material output from the solution filter 121 (FIG. 13) passes through a primary coil 136a of the heat exchanger 136 and flows to a liquid quantity stabilizer 140. Warm water and cold water are mixed and fed to a secondary coil 136b of the heat exchanger 136.

Cold water supplying means is formed in which cold water is sucked by a cold water tank 131a and a cold water tank 132a, and it passes through pipings 133a, 133c and 133e, and returns to the original place.

Warm water supplying means is formed in which warm water is sucked by a warm water tank 131b and a warm water tank 132b, and passes through pipings 133b, 133d and 133f. The input of the secondary coil 136b of the heat exchanging part 136 is connected to a three-way valve 134a via a feed pipe 136c. A discharging side of the secondary coil 136b is connected to a three-way valve 134a through a discharge pipe 136d. A measuring instrument (not shown) to measure temperature of a fluid in the pipe and a temperature adjustor are coupled to a piping 151 (FIG. 13) ranging between the heat exchanging part 136 and the coating booth 170 (FIG. 13). An opening of the three-way valve 134a is controlled by an output of the temperature adjustor. A measuring instrument (not shown) for measuring temperature of a fluid in the discharge pipe 136d near the three-way valve 134a and a temperature adjustor are provided. An opening of the three-way valve 134a is controlled by an output of the temperature adjustor.

Operation of the thus constructed heat exchanger will be described.

When the coating material passes through the piping 151, the measuring instrument detects temperature of the coating material. When the result of the measurement shows that liquid temperature is low, the opening of the three-way valve 134a is controlled in accordance with the measured temperature to increase the amount of warm water fed to the heat exchanging part 136 and to decrease the amount of cold water fed. When the measuring result of the measuring instrument shows that the temperature of the coating material is excessively high, the three-way valve 134a is controlled to increase the amount of cold water fed to the heat exchanging part 136, and to decrease the amount of warm water fed. In this way, the temperature of the coating material is controlled by adjusting the three-way valve 134a and thereby adjusting the amounts of a cooling medium and a heating medium to be fed to the heat exchanging part 136.

There is a case where the temperature of the coating material has been adjusted, but the coating material temperature abruptly decreases by some cause. In such a case, the opening of the three-way valve 134a is controlled so as not to feed a refrigerant to the heat exchanging part 136. And, the opening of the three-way valve 134a is controlled so as to continuously feed a maximum amount of heating medium to the heat exchanging part 136.

In this way, the temperature of coating material may be adjusted by adjusting the amounts of cooling and heating media.

In the heat exchanger 130, it is required to adjust the temperature of only the minimum amount of coating material. In this respect, the heat exchanger is of an energy saving type.

In the case of the coating material which does not require a full-scale heat exchanger as shown in FIG. 18, an air conditioner may be used for the temperature control of the coating material preparing chamber 100.

In an alternative, the tank body 115a is designed to have a double structure. The coating material is made to pass through the interior of the tank body. The double structure side is heated and controlled by steam or warm water.

If a coating liquid made of a material whose viscosity is insensitive to liquid temperature, there is no need of using the heat exchanger or the like, as a matter of course.

In the case mentioned above, the coating material left after it is fed to the two automatic coating apparatuses is returned to the coating material tank 115 via the return piping 155 (circulation method). However, it is preferable to employ a dead-end method in which only the amount of coating material to be used is fed to the two automatic coating apparatuses, and the coating material as fed is used up by the second automatic coating apparatus. By so doing, there is no fear that bubbles are dragged during the course of coating material circulation.

As for the material of the pipings 151 and 152, the return piping 155, the detergent pipings 153 and 154, the pipings 175 and 176 for the both-end coating pressure feed rollers, since the portions which contact with the coating material, such as the pumps, regulators, CCVs and horses, are put under high pressure, those portions are preferably made of stainless (SUS), and the pipings of Teflon or nylon may be used for the portions which are not put under high pressure.

In this automated coating apparatus, as in other coating apparatuses, a flow rate of the coating material sometimes varies by viscosity variation of the coating material, sticking of the coating material to the passages, and the like.

For this type of coating material flow rate stabilizing control, a feedback control is generally employed which minimizes an error, or a difference between a target value of flow rate determined by aqueous coating material characteristic, discharging amount of coating material and the like and an actual flow rate value measured by a flow meter. A PID adjustor or a microcomputer as described in JP-A-63-54969 may be used for the control unit.

In the conventional flow rate stabilizer, a response of the flow meter is not satisfactory or the liquid flow is not stable, and hence, it is difficult to secure high speed and stable control when the flow rate of the coating material varies, or when the liquid flow is interrupted especially when the operation of the liquid discharging means, such as the coating roller, is turned on and off.

To cope with this, a non-contact type flow meter of high response may be used. However, such a flow meter is generally expensive and large in size and weight, and easy to erroneously operate when it is subjected to vibrations or the like. Therefore, when the flow meter is applied to the automatic coating apparatus, problems will arise.

For this reason, the control method in use for the spray gun, disclosed in JP-A-7-232112, was modified for the coating roller and used for the flow rate control. The result was that a flow rate stabilizing was secured which is capable of performing a stable flow rate control independent of the response performance of the flow rate.

This stable flow rate control method will be described with reference to the related drawings.

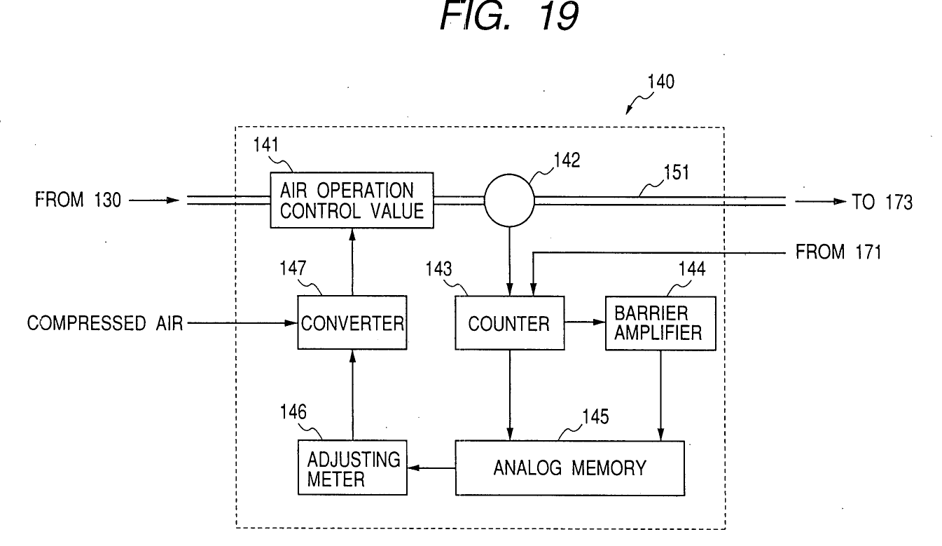

FIG. 19 is a block diagram showing a liquid quantity stabilizer which is used in the second invention.

In the figure, reference numeral 140 is a liquid quantity stabilizer; 141 is an air operation type control valve; 142 is a flow meter; 143 is a counter; 144 is a barrier amplifier; 145 is an analog memory unit; 146 is an adjustor; and 147 is a converter.

A coating material flowing out of the coating material tank 115 (FIG. 13) reaches the liquid quantity stabilizer 140 via the heat exchanger 130 (FIG. 13). In this instance, the coating material flows through the air operation type control valve 141 and the flow meter 142, and the CCV 140 in FIG. 13, and finally is discharged to an object to be coated, from the automatic coating pressure feed rollers 171a and 172a.

The automatic coating pressure feed rollers 171a and 172a are moved forward and backward in link with the driving of the motor, electromagnetic valve, and the like, in response to control signals from the coating robots 171 and 172. The roller discharging air for the automatic coating pressure feed rollers 171a and 172a are turned on and off in its supply in link with the driving of the electromagnetic valve.

Drive control signals (on/off signals) for the electromagnetic valve, which are output from the coating robots 171 and 172, are sent to a counter 143.

The flow meter 142 generates a pulse signal having a frequency based on a flow rate of coating material, and the pulse signal is supplied through the counter 143 and the barrier amplifier 144 to an analog memory unit 145 having D/A converting means and storage means.

The counter 143 receives a pulse signal from the roller brush 12 and on/off signals from the coating robots 171 and 172, and generates a control signal for the analog memory unit 145. The counter 143 responds to a leading edge (transient from an off-state to an on-state of a signal) of a signal from each of the coating robots 171 and 172, and starts a counting operation of a pulse signal derived from the flow meter 142. When a number of pulses reaches a preset value, the counter puts a control signal in an on-state, the signal being fed to the analog memory unit 145 disposed in the feedback path.

A count value of the counter 143 is reset to zero in response to a trailing edge (transient from the on-state to the off-state) of a signal of each of the coating robots 171 and 172, and starts the counting operation in response to the leading edge (transient from the off-state to the on-state). The counter which is reset in its contents and re-starts the counting operation in response to the leading edge of the signal from each of the coating robots 171 and 172, may be used for the counter under discussion.

The analog memory unit 145 outputs a current having a value corresponding to a signal as input when the control signal from the counter 143 is put in an on state. When the control signal is put in an off state, the analog memory unit holds a current value corresponding to the input signal received at that time, and outputs a current signal having such a value.

An output signal from the analog memory unit 145 is applied as a value of a measured flow rate of the liquid to an adjusting meter 146,

The adjusting meter 146 takes the form of a PID adjusting meter for controlling an opening of the air operation type control valve 141, viz., for PID controlling a flow rate of the liquid. The adjusting meter 146 includes a display device for displaying a flow rate set value (target value) and an input value (feedback value) derived from the analog memory unit 145. The adjusting meter 146 compares the set value with the input value, and outputs a control signal corresponding to an error, and its output signal is supplied to the converter 147. The converter 147 adjusts a compressed air pressure supplied thereto through a reducing valve in accordance with a level of an output signal from the adjusting meter 146, and supplies it as a control air to the air operation type control valve 141.

The air operation type control valve 141 adjusts a valve opening in accordance with a supplied compressed air pressure, so that a coating material flow rate is controlled so as to minimize a difference of the input value from the set value independently of environmental factors, such as sticking of coating material to the coating material passage.

Operation of the liquid quantity stabilizer thus constructed will be described.

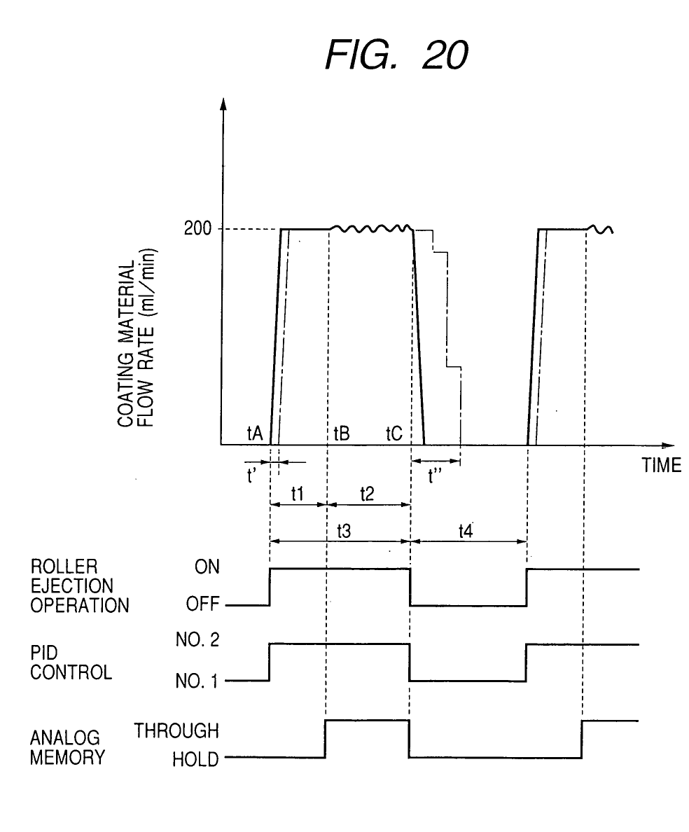

FIG. 20 is a timing chart showing a variation of a flow rate of an aqueous coating material with respect to time in the liquid quantity stabilizer of FIG. 19, and operations of respective portions in the device. The coating rollers 171a and 172a (FIG. 13) are turned on during a time period t3 and turned off during a time period t4 according to control signals from the coating robots 171 and 172 (FIG. 13).

The analog memory unit 145 is in a hold state in which a measured value stored therein is output during a time period that the coating rollers 171a and 172a are in an off state. At a time point tA, the coating rollers 171a and 172a are in an on state. At a time point tB after a time period t1 that the counter 143 counts a preset number of pulses elapses, the analog memory unit is put in a through state in which it outputs a current value corresponding to an input measured value.

At the instant that the coating rollers 171a and 172a are put in an off state at a time point tc, the analog memory unit 145 is put in a hold state and holds a preceding feedback quantity.

During a period t2 from a time point tB to a time point tC, a feedback control through the adjusting meter 146 is performed. During other periods than the period t2, an open loop control based on a hold value of the analog memory unit 145 is performed.

For example, two different values (determined by a proportional sensitivity P, an integration time I and a differential time D) are set in the adjusting meter 146 in order to define its operation. When the coating rollers 171a and 172a are in an off state, a first set value is selected, and when those rollers are in an off state, a second set value is selected.

There is a case that a target flow rate value is somewhat different from a flow rate value stored in the analog memory unit 145. In such a case, if the second set value remains unchanged, the adjusting meter 146 will correct the difference and changes a control air pressure. At this time, a value input to the adjusting meter 146 is a fixed value stored in the analog memory unit 145. Therefore, the difference is not corrected, and the control air pressure continuously changes. To avoid this and to stabilize the control system, the first set value is set at an appropriate value of low response.

The second set value is a set value for smoothly correcting the difference of the measured flow rate from the target flow rate. If the response is excessively high, the stability of the control system is lost and chatter occurs. Conversely, if the response is low, the correction operation is slow. To avoid this, an appropriate value is selected in accordance with a control characteristic required for the system.

Operation of the liquid quantity stabilizer when discharging flow rates of the coating rollers 171a and 172a a little change will be described.

It is assumed that under conditions that the coating rollers 171a and 172a are in an on (operation) state, and the discharge flow rate is kept at 200 cc/min. by the feedback control, a number of pulses output from the flow meter 142 is 222 pulses/min., an output level of the analog memory unit 145 when it is in a through state, is 7.2 mA, an output level of the adjusting meter 146 is 112 mA, and the control air pressure derived from the converter 147 is 0.45 k g f/cm² (gauge pressure: The same shall apply hereinafter.). On this assumption, even if the coating rollers 171a and 172a are put in an off state, current of 7.2 mA is held in the analog memory unit 145, and this current is output. Accordingly, the control air pressure to the control valve 141 is kept at 0.45 k g f/cm².

As shown in FIG. 20, when the coating rollers 171a and 172a are put in an on state at a time point tA, since the flow meter 142 has a response delay, an output signal of the analog memory unit 145 should rise after a time t′, as indicated by a one-dot chain line in the figure.

The analog memory unit 145 holds a measured value (7.2 mA) at a time point where the coating rollers 171a and 172a are put in an off state so long as the control signal from the counter 143 is in an off state. And it outputs the measured value to the adjusting meter 146. The control air pressure is kept at 0.45 k gf/cm². Accordingly, the discharge flow rate of each of the coating robots 171 and 172 swiftly rises to 200 cc/min. That at this time, the PID value of the adjusting meter 146 changes its value to the second set value (No. 2 in the figure) is effective for improving the response performance. At the instant that a time period that the output signal of the flow meter 142 settles down and becomes sufficiently stable, viz., the time period t1 (>t′) defined by the count value of the counter 143, elapses, and the operation of the flow meter 142 is stabilized, a closed loop control is performed by using its output signal as a feedback quantity.

When the coating rollers 171a and 172a are put in an off state at a time point tc, the output signal of the flow meter 142 falls. Also in this case, a level of an input signal to the analog memory unit 145 does not quickly falls since a response delay t″ is present. To cope with this, immediately after the coating rollers 171a and 172a are put in an off state, the analog memory unit 145 is placed in a hold state to keep the output of 7.2 mA. The output holding timing may be set at a time point preceding to the fall timings of the coating rollers 171a and 172a within a range where no disadvantage occurs. During the off period of the coating rollers 171a and 172a, the PID value of the adjusting meter 146 is switched to the first set value (No, 1 in the figure). Therefore, a fixed control air pressure is stably applied to the air operation type control valve 141 while being free from disturbance. And a transient operation is stabilized at the next on-time point. Subsequently, a similar operation is repeated.

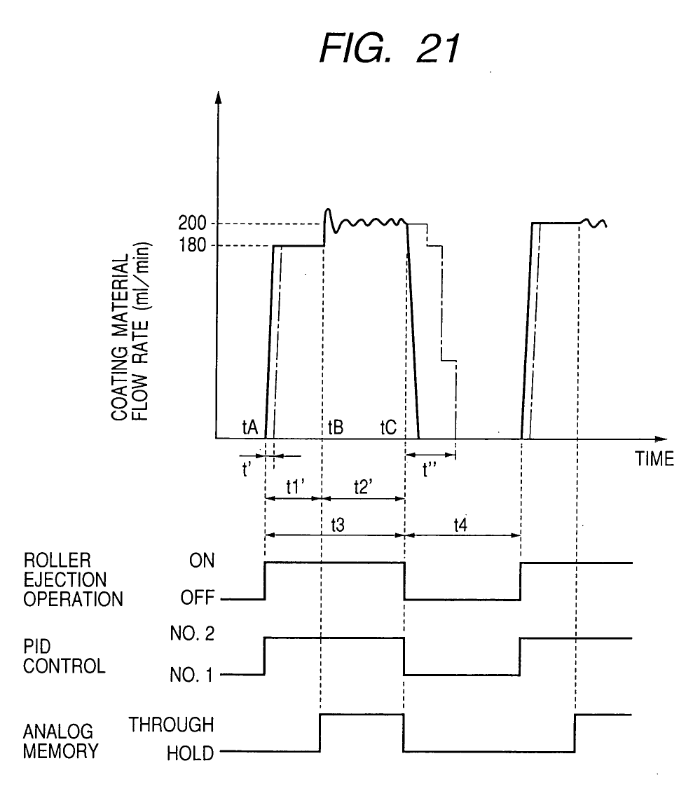

Next description is given about operation of the liquid quantity stabilizer when the discharge flow rates of the coating rollers 171a and 172a vary for a reason that, for example, the coating material sticks to the aqueous coating material passage. The description will be given with reference to FIG. 21.

It is assumed that as shown in FIG. 21, the coating material flow rate originally required till the coating rollers 171a and 172a are turned on drops from 200 cc/min. , which is originally required, to 180 cc/min. A period t1′ (>t′) ranging from an instant that the coating rollers 171a and 172a are put in an on state, defined by a count value of the counter 143, an open loop control in which a manipulation quantity in the preceding on-time is applied to the control valve 141 is performed, and hence, the coating material flow rate is 180 cc/mi. After the period elapses, the analog memory unit 145 applies an output signal (e.g., 7.2 mA) corresponding to a measured value of the flow meter 142 (200 pulses/5 min., which corresponds to 180 cc/min. of the flow rate) to the adjusting meter 146.

As a result, an output value of the adjusting meter 146 increases from 11.2 mA to 12 mA, the control air pressure of the converter 147 is increased from 0.45 kgf/cm² [symbol] 0. 5 kgf/cm², whereby a desired flow rate 200 cc/min. is obtained by adjusting the opening of the control valve. And, when the discharge quantity or flow rate of each of the coating rollers 171a and 172a is equal to a predetermined value, the flow meter generates a number of pulses corresponding to its value. Accordingly, the analog memory unit 145 outputs a corresponding value (7.2 mA). In this state, a difference of the measured value from the target value is not present. Accordingly, the adjusting meter 146 holds an output value (12 mA) at that time. The analog memory unit 145 holds its value even when the coating rollers 171a and 172a are put in an on state. Then, subsequently, the control is performed so that a desired current is produced at the start of the on-state of the rollers.

As described above, in the liquid quantity stabilizer, even if the flow of the coating material is interrupted by the on/off of the coating rollers 171a and 172a, the coating material is smoothly discharged when the on-state rises, and a stable control is ensured.

A number of pulses that the flow meter generates in accordance with a flow rate is counted, and the feedback control is executed based on the count value. If a count value of counting the number of pulses defined by the type of flow meter is set as an initial value in the electronic counter, there is no need of changing a set time of the timer according to a change of the discharge quantity. The number of items to be set to the system by the operator decreases, and complicated operations are avoided.

In some coating conditions, it is required to frequently repeat the on/off of the coating discharge to the coating roller. In such a case, an actual measured value of the discharge quantity measured by the flow meter inserted in the coating passage is fed back to the control device as described in JP-A-5-50013. The control device compares the measured value with a set value of discharge quantity, which is determined in advance on the basis of various coating conditions, such as kinds of coating material and an object to be coated. A coating material regulator inserted in the coating material passage is adjusted based on the comparison result to thereby control the discharge quantity to a set value. This control process is carried out for a first fixed period when the coating conditions change and the coating material starts to feed. Subsequently, during the coating operation under the same coating conditions, it is preferable to keep the coating material regulator in a state of the end of the control time.

In this way, the coating operation under new coating conditions are prepared. Then, the control device is operated for a fixed period of time to cause the spray gun to continuously spray the coating material. During this period, actual discharge quantity is measured by the flow meter, and a measured value is fed back to the control device. The control device compares the measured value with a set value corresponding to the coating conditions. The coating material regulator is adjusted in accordance with the comparison result to control the discharge quantity to the set value. When a fixed time period elapses, the function to adjust the coating material regulator of the control device as the necessity occurs stops, and at the same time, the coating material regulator is held in a final adjusting state of the control time. Subsequently, the coating operation is performed under the same conditions. During this operation, the discharge quantity finally controlled is maintained. Even when the on/off of the coating discharge to the roller is frequently repeated, the coating operation is performed at a fixed discharge quantity at all times.

For the coating conditions, the same thing is true also for the case of the switching between the coating material and the detergent by the CCV, which is employed in the second invention.

An operation control of the coating roller will be described.

To coat by setting the one-end pressure feed/both-end coating pressure feed roller coating device according to the second invention to a drive device, the one-end pressure feed/both-end coating pressure feed roller coating device per se is followable to a curved surface in motion, as will be described later. Therefore, there is no need of using the expensive and high precision drive device, and a general purpose robot apparatus may be used for the drive device. It is satisfactory to use such an operation control as to be capable of controlling the coated object and roller pressing force. A suitable robot may be selected appropriately among from multiarticulate robots, such as a 6-axis robot, and the single axis robot in accordance with the use.

In the case of a reciprocating coating using the one-end pressure feed/both-end coating pressure feed roller coating device, the invention described in Japanese Patent No. 2514856 may be used.

As described above, the coating process by using the coating rollers can be automated by using the coating booth 170 according to the second invention.

A coating method according to the third invention will be described.

As described above, when a rectangular area is coated, a coating film on the peripheral edge of the rectangular area is thicker than on the remaining portion. The cause of such was investigated. The investigation cleared up the cause.

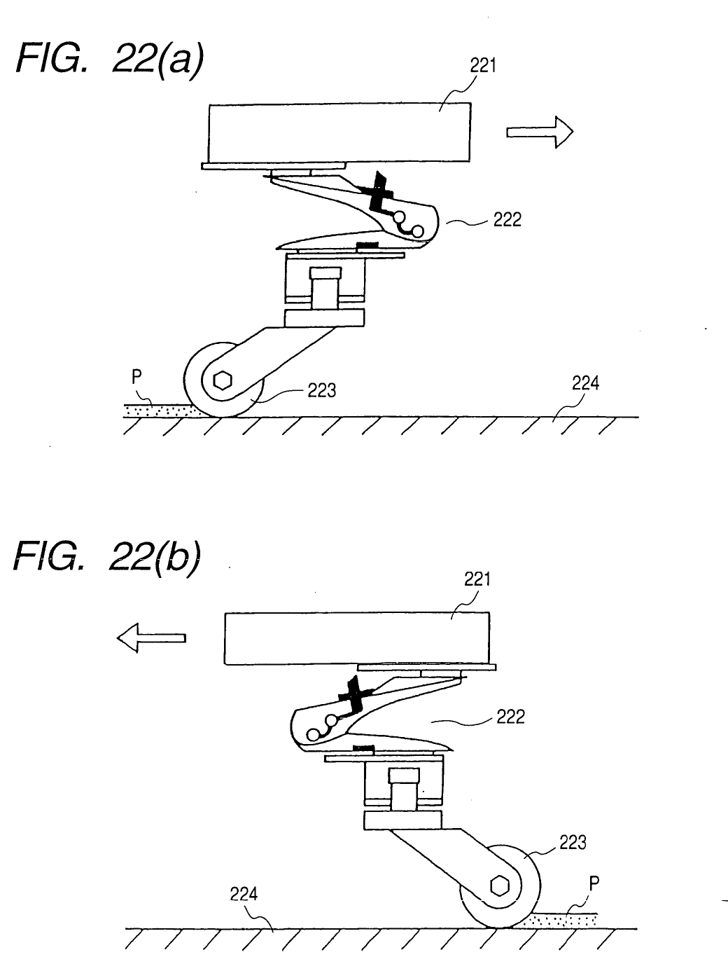

FIG. 22 is a diagram for explaining a coating operation performed by the coating pressure feed roller according to the first invention.

FIG. 22(a) shows a right directional coating process, which is carried out by the coating pressure feed roller attached to a robot arm; and FIG. 22(b) shows a left directional coating process which is carried out by the same. In the figure, 221 is a coating robot arm; 222 is a curved-surface operable coating pressure feed roller attached to the tip of each arm of the coating robot arm 221; 223 is a coating pressure feed roller brush; and 224 is a coated surface; and P is coated coating material. In the same coating direction, when a wrist of the coating robot is turned 180° from a state (a), the feeding roller is directed as in a state (b). When the feeding roller is moved backward from state (b), an efficient coating locus is obtained, and the coating time is reduced.

The feeding roller may be moved backward while being in the state (a), viz., it is reciprocatively moved.

A double coating roller may be used which is a combination of the coating pressure feed roller in the state (a) and the coating pressure feed roller in the state (b).

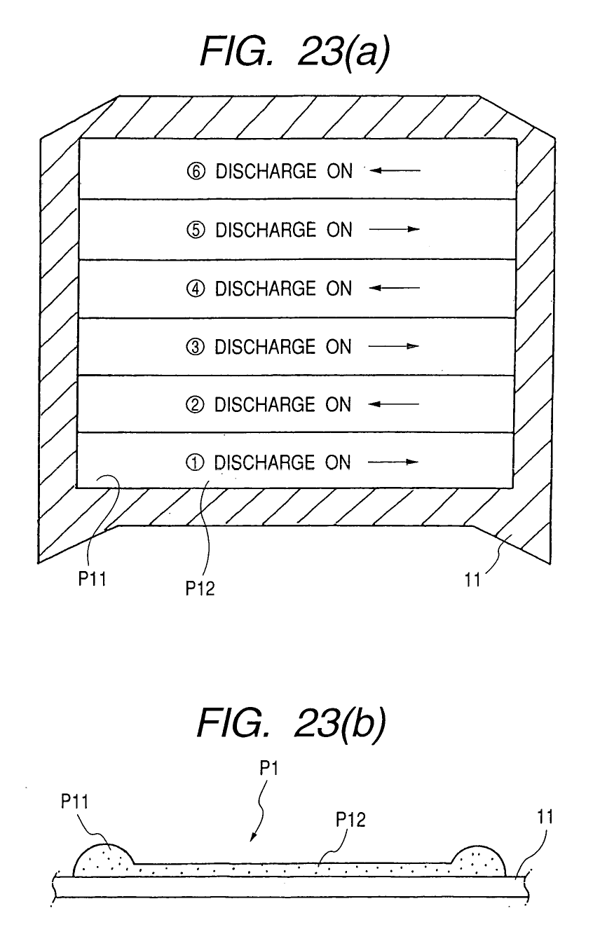

FIG. 23 is a diagram for explaining a hood coating of the automobile by a conventional coating method: FIG. 23(a) is a plan view for explaining an order of coating operations; and FIG. 23(b) is a cross sectional view showing the result of the coating operation. In FIG. 23, to coat a hood of an automobile in a broad rectangular area, the coating pressure feed roller brush 10 is put at the left end of a first long area indicated by (1) with the coating robot 171. The coating pressure feed roller brush, which is in the state (a) of FIG. 22, is moved from left to right, while coating the area (ON), and is stopped at the right end.

Then, the coating pressure feed roller brush 10 is raised and turned over with the coating robot 171; The feed roller brush is put on the right end of a long area (2); The feed roller brush, which is in the state (b) of FIG. 22, is moved from right to left, while coating the area (ON), and is stopped at the left end.

Subsequently, the coating pressure feed roller brush 10 is raised, and is put on the left end of a long area indicated by (3) with the coating robot 171; The feed roller brush, which is in the state (a) of FIG. 22, is moved from left to right, while coating the area (ON), and is stopped at the right end.

Next, the coating pressure feed roller brush 10 is raised and turned over with the coating robot 171, and is put on the left end of a long area (4) with the coating robot; The feed roller brush, which is in the state (b) of FIG. 22, is moved from right to left, while coating the area (ON), and is stopped at the left end.

As seen from FIG. 23(b) showing a distribution of a thickness of a coating film P1 thus coated in a longitudinal section, a thickness P12 of the coating film is thin in a central portion of the rectangular area since the coating pressure feed roller brush 10 moves on and along the central portion. At ends of the rectangular area, the coating pressure feed roller brush 10 temporarily stops. Accordingly, stagnant coating material are formed thereat, and a thickness P11 of the coating material is abnormally large. Sometimes, this causes sagging of the coating material under influence of configuration and slope.

A coating method which is capable of normally coating an object to be coated without formation of uncoated parts or excessively coated parts on the surface of the object, and by economically and efficiently using the coating material, is disclosed in Patent Document 2. In this technique, a coating material spray gun, which is confronted with a brush part of a coating roller brush having a core part and a brush part, sprays the coating material to an outer surface of the brush part to thereby feed the coating material. Further, complicated work to locate a dummy coated object is required. In this respect, the disclosed technique is not suitable for the automatization of the coating work.

(1) Consecutive Stages of the Automated Coating Apparatus

Pre-stages of forming a protecting film for protecting a coating film of an automobile is as follows: 1) To clean a car by water washing; 2) to drain the washing water; 3) to mask the car body except a portion thereof on which a protecting film is to be formed; 4) to coat a protecting film; 5) to perform a correction and finishing coating if necessary; and 6) to dry the coated car. If a surface of the automobile is not soiled, the stages 1) to 3) may be omitted.

(1) An automobile W on which a protecting film is formed is subjected to a washing stage. In the stage, the car body is entirely washed by a car washing machine of the shower type which uses a rotary brush, to thereby remove rainwater, dust and the like sticking to the surface of the coating film. In the cold season, water drops attached to the coating film surface is frozen to possibly damage the coating film surface. To avoid this, warm water of 30 to 50° C. is used for washing.

(2) In the washing water draining stage following the washing stage, washing water left on the surface of the coating film of the automobile W, which is washed in the washing stage, is removed by blowing hot air of about 30 to 70° C. onto the coating film surface. The warm water used in the washing stage and the hot air used in the washing water draining stage make good the coating of an aqueous coating material, which is carried out in a coating stage as a post stage. Therefore, a surface temperature of the automobile is appropriately kept. The surface temperature of the automobile is 15° C. or higher, preferably 20 to 30° C. in consideration of the film formability of the coating material.

(3) In the next masking stage, to mark off the boundary between a coating area to be coated with an aqueous coating material and a non-coating area, a masking tape is applied to the surface of the automobile W having the washing water drained and dried in the washing water draining stage. The intake duct opened at the engine hood, and non-coating parts, e.g., resin parts, located within the coating area, are covered with a cover or the like.

(4) In the coating stage, the coating area defined by the masking tape in the masking stage is coated with an aqueous coating material mainly containing acrylate emulsion (e. g., “Wrap Guard L”, manufactured by Kansai Paint corporation) by using the roller brush coating device.

(5) In the next finishing coating stage, which may be carried out if necessary, the masking tape applied in the masking stage is peeled off, and the cover is removed. In a finishing coating, small uncoated portions in the coating area are manually coated with an aqueous coating material by using a brush or a small roller brush. The masking stage, the coating stage, and the finishing coating stage are carried out within the coating booth.

(6) In the subsequent drying stage, the coated car is placed in an IR drying furnace, and irradiated with infrared rays for about 30 to 90 seconds, thereby enhancing the drying of the coated aqueous coating material inclusive of the interior thereof. Subsequently, the aqueous coating material is dried by uniformly heating the entire coated car body by using hot air drying furnace or by using only the hot air drying furnace, thereby forming a protecting film. Where the hot air drying furnace is used, it is preferable to dry the coating material for about 210 minutes under conditions that a drying temperature is 50 to 100° C. and a hot air velocity is 0.5 to 8 m/sec., to secure a satisfactory film formability of the aqueous coating material and to protect attached components such as various kinds of electric components.

The above-mentioned stages may be substituted by an in-line stages. In this case, after the coating stage (intermediate and finish coating) of the automobile ends and an inspection stage ends, the car body is coated with the protecting coating material, and dried, and thereafter components such as meters are attached to the car, whereby a finished car is presented.

The “coating material” used here is a coating material for forming a coating film for protecting the coating of the car body. A viscosity of the coating material is higher than that of normal color coating material. Accordingly, it is difficult to perform such a coating for the formation of the protecting film by use of a conventional spray type automatic coating apparatus. For this reason, the manual work using the coating roller is used for the coating.

The automatic coating roller according to the invention filed by the Applicant of the present Patent Application enables the stages of forming a protecting film of high viscosity to be automated.

The automated coating apparatus is used for automating the coating stage 4) of those stages 1) to 6). The roller flattening is carried out before the coating method according to the third invention.

2) Roller Flattening:

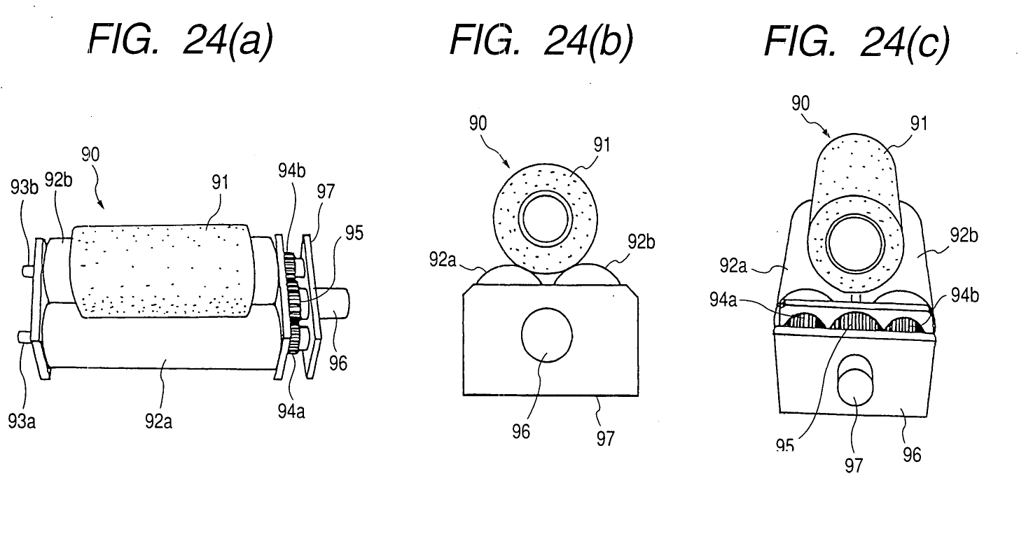

FIG. 24 shows an example of a roller flattening device: FIG. 24(a) is a perspective view showing the roller flattening device as viewed from diagonally upward of the front; FIG. 24(b) is a side view of the roller flattening device as viewed from the right side in FIG. 24(a); and FIG. 24(c) is a perspective view of the roller flattening device as viewed from diagonally upward in FIG. 24(b).

In the figure, reference numeral 90 is a roller flattening device, and 91 is a coating pressure feed roller. 92a and 92b are contact rollers; 93a and 93b are rotary shafts of the contact rollers 92a and 92b; 94a and 94b are gears; 95 is a drive gear for driving the gears 94a and 94b; 96 is a motor for rotating the drive gear 95; and 97 is a mounting plate for mounting the gears 94a and 94b and the motor 96.

When the motor 96 is driven to rotate, the drive gear 95 rotates and then the follower gears 94a and 94b rotate in the same direction and at equal speeds. Accordingly, the coating pressure feed roller 91 put on the boundary between the follower gears 94a and 94b by gravity, also rotates.

When the coating pressure feed roller 91 in which a coating material has accumulated in a lower part of the brush by gravity is rotated several turns, the coating material is distributed uniformly over the entire surface of the roller. Thereafter, the coating material is applied to the coated object by the coating pressure feed roller 91 to thereby form a coating film uniform in thickness.

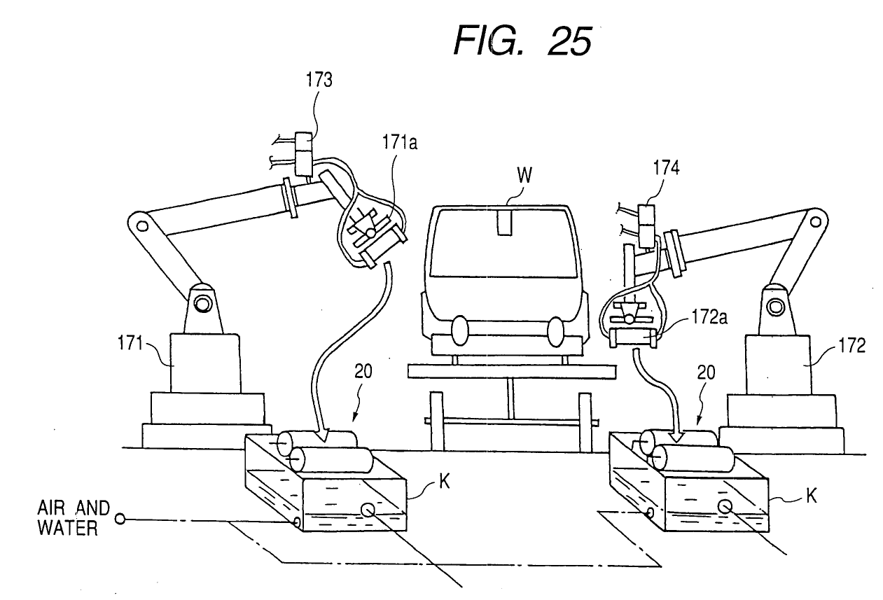

FIG. 25 is a conceptual diagram typically showing how a roller flattening device in FIG. 24 is used by the coating robot within a coating booth.

In the figure, reference numeral 90 is a roller flattening device according to a first embodiment; 171 and 172 are coating robots; 171a and 172a are one-end or both-end coating pressure feed roller attached to the tips of the arms of the coating robots 171 and 172; 173 and 174 are CCVs attached to parts near the tips of the arms of the coating robots 171 and 172; K is a coating material recovery bath; and W is an automobile as an object to be coated.

Before the coating operation, the coating pressure feed coating rollers 171a and 172a receive the coating material from the solid cylindrical body 11 (FIGS. 13 and 14). At this time, the coating material on the coating pressure feed coating rollers 171a and 172a has deviated to a lower part by gravity. The coating pressure feed coating rollers 171a and 172a are transported to above the roller flattening device 20 by the coating robots 171 and 172, and put on the contact rollers. Thereafter, the contact rollers are rotated to uniformly distribute the coating material on the coating pressure feed coating rollers 171a and 172a.

Thereafter, the coating method according to the third invention is executed.

The coated object may be washed on the roller flattening device, and made wait. At the rest, noon recess, and operation end of the automobile line, the coated object is preferably washed on the roller flattening device. After washed, it may be made wait.

Coating method of the third invention:

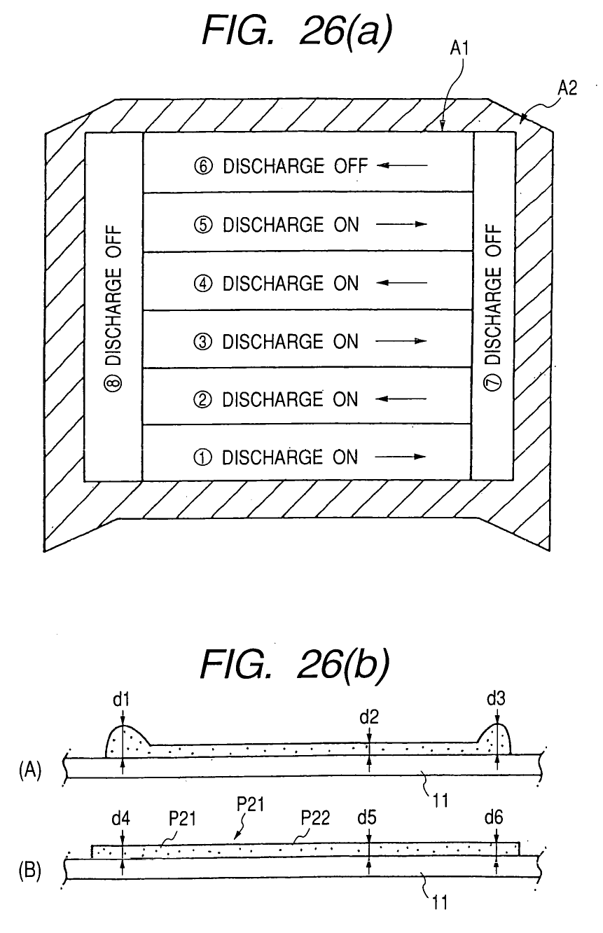

FIG. 26 is a diagram for explaining a coating method of the third invention by using the coating of a hood of an automobile: FIG. 26(a) is a plan view for explaining an order of coating operations; and FIG. 26(b) is a cross sectional view for explaining the result of the coating.

In FIG. 26, to coat a rectangular broad area A1 of a hood 11 of an automobile, the coating pressure feed roller brush 10 is put at the left end of a first long area indicated by (1) with the coating robot 171 (FIG. 11). A difference between the long area (1) in FIG. 26 and the long area (1) in FIG. 3 in the conventional coating method is as follows: In the conventional coating method, the left end of the long area (1) is the left end of the broad area A1. In the coating method of the third invention, the coating operation starts at a point located inside from the left end of the broad area A1 by a maximum distance corresponding to the width of the coating pressure feed roller (This point will be referred to as a “left inside point”.). In other words, the coating operation starts from a point located inside by a distance corresponding to an area lager than the half of the area corresponding to the long area (8) in the figure.

The same thing is true for a point where the coating of the long area (1) ends. In the conventional coating method, the coating end point of the long area (1) is the right end of the broad area A1. In the third invention, the coating ends at a point located inside by a maximum distance corresponding to the width of the coating pressure feed roller from the right end of the broad area A1 (This point will be referred to as a “right inside point”.). In other words, the coating progresses up to a point located inside by a distance corresponding to an area lager than the half of the area corresponding to the long area (7) in the figure.

Then, the coating robot 171 lifts up the coating pressure feed roller brush 10 and turns over it, and puts it on the right inside point of the long area (2). The coating pressure feed roller brush in a state of FIG. 22(b) coats (ON) from right to left while discharging the coating material, and stops at the left inside point.

Subsequently, the sequence of coating operations is repeated.

In the long area (6) of the final line, the coating robot 171 lifts up the coating pressure feed roller brush 10 at the right inside point of the long area (7), and turns over it, and puts it on the right inside point of the long area (6), and the coating pressure feed roller in the state of FIG. 22(b) rolls from right to left. At the right inside point of the long area (7), the coating robot 171 lifts up the coating pressure feed roller brush 10 and turns over it, and puts it at the right inside point of the long area (6), and the coating pressure feed roller in the state of FIG. 22(b) rolls from right to left. In this case, the coating pressure feed roller brush 10 rolls while not discharging the coating material. If it discharges the coating material, the amount of discharging coating material is considerably small.

Subsequently, of the broad area A1, the areas not yet coated which are both ends of the broad area are coated. In this case, of importance is that as in the case of the long area (6), the coating pressure feed roller brush 10 rolls while not discharging the coating material, and if discharging, the amount of discharging coating material is considerably small.

In the long area (7) vertically arrayed, the coating robot 171 puts the coating pressure feed roller brush 10 at the lowest position, and the coating pressure feed roller brush is rolled from lower to upper while not discharging the coating material (if it discharges the coating material, a considerably small amount of coating material is discharged).

Also in the uncoated area (8) in the broad area A1, the coating robot 171 puts the coating pressure feed roller brush 10 at the lowest position, and the coating pressure feed roller brush is rolled from lower to upper or from upper to lower while not discharging the coating material (if it discharges the coating material, a considerably small amount of coating material is discharged). And, the coating operation of the broad area A1 is completed.

The coating results of the coating thus performed by the third invention were examined. The result was as shown in FIG. 26(b). In the figure, (a) of FIG. 26 is a longitudinal sectional view showing a middle stage that the coating of the long areas (1) to (6) is completed, and (b) a final stage that the long areas (7) and (8) vertically arrayed is completed. In the case of (a), the coating pressure feed roller brush moves on the central portion of the rectangular area. A thickness d2 of the coating film is thin. At the end part of the rectangular area, the coating pressure feed roller brush stops. Accordingly, a thickness of the coating film is thick. Thus, the thickness of the coating film is not uniform.

In the invention, thereafter, the roller rolls on a portion of a thickness d3 (long area (7) and a portion of a thickness d1 (i.e., long area (8)) in a state that it does not discharge the coating material to thereby flatten those portions. The thickness d1 portion is expanded, so that the coating film P2 is made uniform in thickness over the entire area thereof. Finally, the thicknesses d4 and d6 at both ends of the coating film, and the thickness d5 of the central portion thereof are made equal, as shown in (b).

Thus, in the third invention, even if the stagnant coating material is formed, the flattening operation by the empty roller is performed in the next step. Accordingly, a thickness P1 of the coating film is uniform, and hence, the sagging caused by the stagnant coating material is removed.

In the coating method mentioned above, in only the coating of the final long area (6), the coating pressure feed roller brush is rolled while not discharging the coating material. By so doing, the thickness of the coating film is not increased at both ends of the long area (6), while the coating film is thick at the ends of the long areas (1) to (5) in the conventional coating method. When the coating pressure feed roller brush flattens the portions of the increased thicknesses d1 and d2, while moving from lower to upper or from upper to lower, and reaches the final long area (6), this long area does not include the portions of the thicknesses d1 and d2, and hence, there is no need of uniformly expanding the coating film, and the thickness uniformizing process step ends.

A width of the uncoated area is determined by an amount of stagnant coating material formed in the pre-stage. For example, as the amount of stagnant coating material increases, the width of the uncoated area is broadened, and when it is small, the uncoated area is narrow.

The width of the uncoated area should be shorter than that of the coating pressure feed roller, as a matter of course.

If the coating width overlapping is excessive, the coating efficiency (time) decreases. 10% overlapping is preferable. For example, the overlapping width is preferably about 20 mm when the coating width is 170 mm.

Coating conditions in an example where the instant coating method is used are:

Weight of the coating pressure feed roller

0.6 to 1.5 kgf (8.8 to 147N)

Coating width: 170 mm (7-inch roller brush)

Overlapping width: 10 to 50% (10%=about 20 mm)

Roller linear velocity: 10 to 40 m/min.

Roller coating direction: right direction

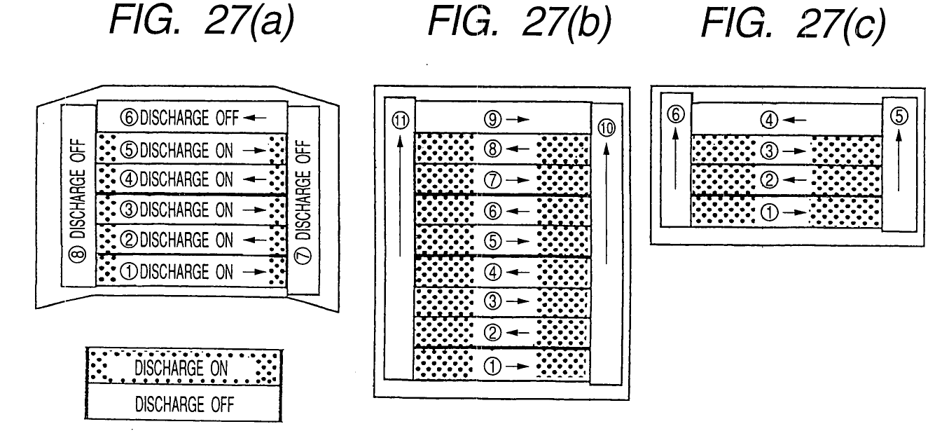

FIG. 27 is a plan view showing three examples of portions of an automobile to which the coating method of the third embodiment may be applied: FIG. 27(a) shows a hood; FIG. 27(b) shows a roof; and FIG. 27(c) shows a trunk.

The following facts are applied commonly to FIGS. 27(a) to 27(c). In the long area of the uppermost line ((6) of the hood, (9) of the roof, and (4) of the trunk) and the vertical long areas on both ends ((7) and (8) of the hood, (10) and (11) of the roof, and (5) and (6) of the trunk), the coating pressure feed roller brush rolls while not discharging the coating material or discharging a considerably small amount of coating material.

In other lateral long areas than the above, the coating pressure feed roller brush discharges the coating material, and the coating pressure feed roller brush is turned over every line feed, and returned to the original position. Advantages resulting from the roller thus operated are as described above.

The hood, the roof and the trunk include curved surfaces in addition to the flat surfaces. Where the conventional coating rollers are used, it is impossible to automate the coating process. However, the coating robot 171 with the coating pressure feed rollers (FIG. 22) of the invention filed by the Applicant of the present Patent Application enables the coating process to be automated.

To coat portions where the roller is not followable to surface configuration, for example, the area A2 other the broad area A1 in FIG. 26, the worker supplementally coats there by use of the brush or the roller. Alternatively, to the supplementary coating work, a small roller more handy than the coating pressure feed roller is used or a slit nozzle producing little dust and a clear edge of the spray pattern of the coating material is attached to the coating robot.

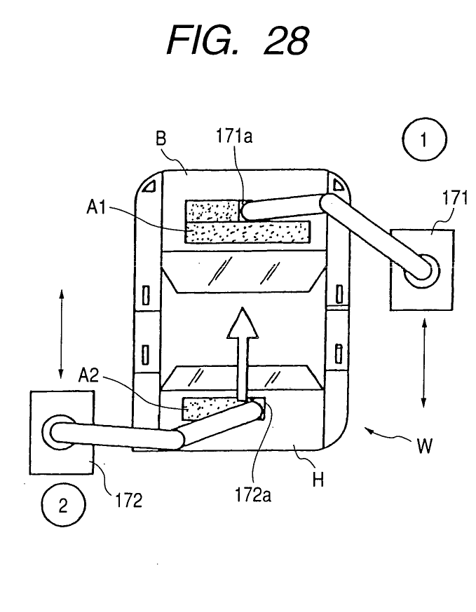

FIG. 28 is a plan view an example of an efficient coating process by using coating robots 171 and 172 shown in FIGS. 25. The coating robot 1 causes the coating pressure feed roller 171a to coat only the hood by the coating method of the third invention as in the case of the broad area A1. At the same time, a coating robot 2 causes the coating pressure feed roller 172a to coat the areas from the trunk to the roof by the coating method of the third invention as in the case of the area A2.

To effect an efficient coating, it is preferable that the automobile is moved, and the coating rollers 1 and 2 are also moved in link with the former.

As describe above, according to the third invention, there is no need of the manual work for the coating by roller coating. Accordingly, the coating material is uniformly applied to the entire roller, and hence, nonuniformity of the coating film thickness is not produced. There is no need of repeating such a process that the coating material is applied to the roller several times, and then the coating material is infiltrated again into the roller. This advantageously results in reducing labor cost and working hours, and the coating booth. A coating yielding is improved. In particular, the coating method enables a coating process of uniformizing the thickness of the coating film over the entire area to be automated.

Further, the automatic coating apparatus of the roller type according to the present invention may be applied to the coated objects which have been coated by use of the roller, without any limitation. Specific examples of those objects are objects concerning vehicles and construction, ships, furniture, and objects concerning roads.

The coating material used by the third invention is not limited to the coating material which is conventionally used by the known roller coating process, but maybe an aqueous coating material , an organic solvent coating material and the like.

While the invention has been described in detail by using some specific embodiments, it should be understood that the invention is not limited to those embodiments, but may variously be modified, altered and changed within the true spirits and scope of the invention.

This patent application is based on Japanese Patent Application Nos. 2002-174595, filed Jul. 14, 2002, 2003-012430, filed Jan. 21, 2003, 2003-012466, filed Jan. 21, 2003, and 2003-012695, filed Jan. 21, 2003, the disclosure of which are incorporated herein by reference in their entirety.

### INDUSTRIAL APPLICABILITY

As seen from the foregoing description, a coating pressure feed roller defined in claim 1 comprises: a solid cylindrical body being solid except an axial center hole passed through the axial center of the solid cylindrical body, and radial holes radially extended from a plurality of positions of the axial center hole; and a roller brush applied to the outer periphery of the solid cylindrical body. With such a construction, a volume occupied by a coating material in an area of the solid cylindrical body is reduced. There is no need of the roller shaft, which is needed in the conventional coating device. The remaining coating material after the coating work ends is small in amount, a waste of coating material is small, maintenance of the coating device is easy, and the number of component parts is reduced.

A coating pressure feed roller defined in claim 2 comprises: a plurality of divided roller brush assemblies each formed with a solid cylindrical body being solid except an axial center hole passed through the axial center of the solid cylindrical body, and radial holes radially extended from a plurality of positions of the axial center hole, and a roller brush applied to the outer periphery of the solid cylindrical body; an elastic member by which the divided roller brush assemblies are pulled to each other; and a flexible tube passing through the axial center holes of all of the divided roller brush assemblies; wherein holes formed in the flexible tube are aligned with the radial holes. With such a construction, as the invention defined in claim 1, a volume occupied by a coating material in an area of the solid cylindrical body is reduced. There is no need of the roller shaft, which is needed in the conventional coating device. The remaining coating material after the coating work ends is small in amount, a waste of coating material is small, maintenance of the coating device is easy, and the number of component parts is reduced. Further, the coating pressure feed roller is operable adaptively for a surface locally curved. Accordingly, the curved surface may be coated excellently.

In a coating pressure feed roller defined in claim 3, which depends from claim 1 or 2, a groove extending in the circumferential direction, which is connected to the outlets of the radial holes, is formed in a surface of the solid cylindrical body. With such a feature, the coating material flowing out of the radial holes swiftly spreads in the circumferential direction along a circumferential groove. As a result, the coating material is spread over the entire surface of the roller to thereby secure a uniform coating.

A roller coating device defined in claim 4, which depends from claim 1 or 2, comprises: a coating pressure feed roller defined by any of claims 1 to 3; coating-material press feeding pipes connected to both ends of the axial center hole of the solid cylindrical body of the coating pressure feed roller; and an arm part for supporting the coating pressure feed roller at both ends of the coating pressure feed roller. With this feature, the coating material is supplied from both ends of the roller to the roller, and is supported at both ends. A liquid pressure is uniform over the axial center hole passing through the axial center. A pressing force applied to the coating pressure feed roller is uniform, so that the coating material is distributed over the entire roller.

A curved-surface operable roller coating device defined in claim 5 comprises: a coating pressure feed roller; coating-material press feeding pipes for pressure feeding the interior of the coating pressure feed roller from both ends of the coating pressure feed roller; an arm part for supporting the coating pressure feed roller at both ends of the coating pressure feed roller; a turnable support mechanism for supporting the arm part such that the arm is rotatable in a plane parallel to a vertical surface including the axis of the coating pressure feed roller; and a vertically movable support mechanism for supporting the arm part such that the arm part is vertically movable. With such a construction, the support displaces the roller brush in conformity with a coated surface. The resultant coating is free from spots. The vertically movable support mechanism brings the roller brush into contact with the coated surface at a fixed pressure. Therefore, a coating having a uniform thickness is secured.

In a curved-surface operable roller coating device defined in claim 6, the coating pressure feed roller defined in claim 5 is the coating pressure feed roller defined by any of claims 1 to 3. Such a construction reduces the remaining coating material amount, and eliminates a waste of coating material. Maintenance is easy, and the coating material is spread over the entire roller surface. Therefore, the thickness uniformity of the coating is enhanced, and a favorable use handiness is secured.

An automatic coating apparatus of the roller type defined in claim 7 comprises: a three-dimensionally moving robot being movable in three dimensional directions, the curved-surface operable roller coating device defined by claim 5 or 6 being attached to the tip of arms of the robot; a robot control unit for controlling the three-dimensionally moving robot; a pump control unit for controlling a flow rate of a coating material to be pressure fed to the curved-surface operable roller coating device. With such a construction, robot operation (the number of revolutions of the roller brush, pressing force), the amount of coating material fed, liquid feeding pressure and the like may automatically be set allowing for viscosity of the coating material, coating material environments (temperature, humidity, etc.) and the like. A uniform roller coating may be automated.

To achieve the second object, there is provided a automated coating apparatus (defined in claim 8) having a coating material tank supplied with a coating material from a coating material can, a coating device for coating a coating material on an object to be coated, a piping ranging from the coating material tank to the coating device, and a pump, provided in the piping, for feeding the coating material to the coating device. In the automated coating apparatus, the coating device comprises: a coating pressure feed roller including a solid cylindrical body being solid except an axial center hole passed through the axial center of the solid cylindrical body, and radial holes radially extended from a plurality of positions of the axial center hole, and a roller brush applied to the outer periphery of the solid cylindrical body; a curved-surface operable roller coating device including coating-material press feeding pipes connected to both ends of the axial center hole of the solid cylindrical body of the coating pressure feed roller, an arm part for supporting the coating pressure feed roller at both ends of the coating pressure feed roller, a turnable support mechanism for supporting the arm part such that the arm is rotatable in a plane parallel to a vertical surface including the axis of the coating pressure feed roller, and a vertically movable support mechanism for supporting the arm part such that the arm part is vertically movable; a three-dimensionally moving robot being movable in three dimensional directions, the curved-surface operable roller coating device defined by claim 5 or 6 being attached to the tip of arms of the robot; a robot control unit for controlling the three-dimensionally moving robot; and a coating material flow rate control unit for controlling a flow rate of a coating material to be pressure fed to the curved-surface operable roller coating device. With such a feature, the coating device of the roller type with the both-end pressure feed roller is able to adapt for the curved surface. By using the coating device, the coating processes by the coating roller may be automated.

A automated coating apparatus (defined in claim 9) has a coating material tank supplied with a coating material from a coating material can, a coating device for coating a coating material on an object to be coated, a piping ranging from the coating material tank to the coating device, and a pump, provided in the piping, for feeding the coating material to the coating device. In the automated coating apparatus, the coating device comprises: a coating pressure feed roller including a solid cylindrical body being solid except an axial center hole passed through the axial center of the solid cylindrical body, and radial holes radially extended from a plurality of positions of the axial center hole, and a roller brush applied to the outer periphery of the solid cylindrical body; a curved-surface operable roller coating device including coating-material press feeding pipes connected to one end of the axial center hole of the solid cylindrical body of the coating pressure feed roller, an arm part for supporting the coating pressure feed roller at one end of the coating pressure feed roller, a turnable support mechanism for supporting the arm part such that the arm is rotatable in a plane parallel to a vertical surface including the axis of the coating pressure feed roller, and a vertically movable support mechanism for supporting the arm part such that the arm part is vertically movable; a three-dimensionally moving robot being movable in three dimensional directions, the curved-surface operable roller coating device defined by claim 5 or 6 being attached to the tip of arms of the robot; a robot control unit for controlling the three-dimensionally moving robot; and a coating material flow rate control unit for controlling a flow rate of a coating material to be pressure fed to the curved-surface operable roller coating device. The coating device of the roller type with the one-end coating pressure feed roller is also adaptable for the curved surface, like the coating device defined in claim 8. Accordingly, the coating process which cannot be automated by conventional art, can also be automated.

In a automated coating apparatus defined in claim 10, which depends from claim 8 or 9, a solution filter for removing foreign matters mixed into the coating material is provided in the piping ranging from the coating material tank to the coating device. Since the filter filters out foreign materials, beautiful coating is secured, and device trouble by the foreign materials is prevented.

In a automated coating apparatus defined in claim 11, which depends from any of claims 8 to 10, a liquid quantity stabilizer using a flow meter, for controlling a flow rate of coating material in order to eliminate a variation of a flow rate of coating material within the piping and to keep constant an amount of coating material coated by the coating device, is provided in the piping ranging from the coating material tank to the coating device. The liquid quantity stabilizer keeps the amount of coating material coated by the coating device at a fixed value. The resultant coating is beautiful with no shade.

In a automated coating apparatus defined in claim 12, which depends from any of claims 8 to 11, a heat exchanger for adjusting temperature of the coating material in the coating device to an optimum temperature and supplying the coating material temperature adjusted is provided in the piping ranging from the coating material tank to the coating device. With such a construction, the coating material in the coating device may be adjusted to have an optimum temperature. Accordingly, the viscosity of the coating material may be kept constant through the four seasons. A predetermined control may be executed at all times.

A automated coating apparatus defined in claim 13, which depends from any of claims 8 to 12, further comprises a return piping for returning the remaining coating material of the coating material having been fed from the coating material tank to the coating device, the remaining coating material being left while not used for coating.

With such a feature, the remaining coating material may be returned to the coating material tank. Accordingly, the coating material may be circulated irrespective of use of the coating material. A necessary amount of coating material may be used whenever it is required. The control of the discharge quantity of coating material is easy.

In a automated coating apparatus defined in claim 14, which depends from any of claims 8 to 13, the fore end of the return piping is projected into a liquid level within the coating material tank and is bent in the circumferential direction along the side wall the coating material tank.

With such a technical feature, the coating material in the coating material tank is stirred with a simple construction.

A automated coating apparatus defined in claim 15, which depends from any of claims 8 to 14, further comprises a coating material color select valve provided in the piping ranging from the coating material tank to the coating device; a piping for guiding a detergent from a detergent tank to the coating material color select valve; and a pump, provided in the piping, for supplying a detergent to the coating material color select valve. With such a technical feature, the coating device may be washed with a simple construction.

To achieve the third object, there is provided a coating method (claim 16) for coating an object to be coated in a manner that a roller is rolled while a coating material is pressure fed from the interior of the roller to the outer periphery thereof, in which a predetermined long area is coated from one end to the other end by the coating pressure feed roller, the coating pressure feed roller is stopped at the other end, to coat a long area adjacent to the long area, the coating pressure feed roller is moved to one of the ends of the adjacent long area, and the long area is coated again toward the other end, and the coating operations are sequentially repeated to finally coat a broad area. In the coating method, as a first step, an area of the broad area except an area as a maximum corresponding to a width of the coating pressure feed roller, which is located inside from the both ends of the broad area is entirely coated by the coating method, and as a second step, the coating pressure feed roller is rolled from a first long area to a final long area in the uncoated area, while discharging no coating material or a small amount of coating material. By such a coating method, a rectangular area may be coated uniformly over its entire area by using the coating robot which may be automated.

In a coating method defined in claim 17, in the coating method defined in claim 16, the coating pressure feed roller is rolled while discharging no coating material or a small amount of coating material, in a final long area in the broad area. This construction eliminates formation of stagnant coating material at the end of the uppermost area. A more fine and uniform thickness of the coating in the upper part of the rectangular area is secured.

In a coating method defined in claim 18, in the coating method of claim 16, as the amount of coating material stagnating at the end increases, the width of the uncoated area is increased. With this feature, a thickness of the coating film may be made uniform even if the viscosity of the coating material varies by the kind of coating material and coating temperature.

In a coating method defined in claim 19, flat and curved portions to which the coating pressure feed roller is followable, such as hood, roof, trunk, bumper, fender or door of an automobile, is coated by the coating method defined by any of claims 16 to 18, and portions where the coating pressure feed roller is not followable, is coated manually by a brush or a roller, or automatically by a coating robot including a small roller smaller than the coating pressure feed roller or a slit nozzle. This feature enables the portions to which the coating pressure feed roller is followable, may be coated.

In a coating method in use for an automobile, in the coating method defined in claim 19 which includes at least one coating pressure feed roller for coating an object to be coated in a manner that a roller is rolled while a coating material is pressure fed from the interior of the roller to the outer periphery thereof, at least one of the hood, roof, trunk, bumper, fender and door is coated with a first coating pressure feed roller, and at least one of components other than the components coated by the first coating pressure feed roller is coated with a second coating pressure feed roller. With this feature, the automobile may be coated uniform in thickness, and efficiently.

1. A coating pressure feed roller comprising:
a solid cylindrical body being solid except an axial center hole passed through the axial center of said solid cylindrical body, and radial holes radially extended from a plurality of positions of said axial center hole; and
a roller brush applied to the outer periphery of said solid cylindrical body.

2. A coating pressure feed roller comprising:
a plurality of divided roller brush assemblies each formed with a solid cylindrical body being solid except an axial center hole passed through the axial center of said solid cylindrical body, and radial holes radially extended from a plurality of positions of said axial center hole, and a roller brush applied to the outer periphery of said solid cylindrical body;
an elastic member by which said divided roller brush assemblies are pulled to each other; and
a flexible tube passing through the axial center holes of all of said divided roller brush assemblies;
wherein holes formed in said flexible tube are aligned with said radial holes.

3. A coating pressure feed roller according to claim 1 or 2, wherein a groove extending in the circumferential direction, which is connected to the outlets of said radial holes, is formed in a surface of said solid cylindrical body.

4. A roller coating device according to claim 1 or 2, comprising:
a coating pressure feed roller defined by any of claims 1 to 3;
coating-material press feeding pipes connected to both ends of the axial center hole of said solid cylindrical body of said coating pressure feed roller; and
an arm part for supporting said coating pressure feed roller at both ends of said coating pressure feed roller.

5. A curved-surface operable roller coating device comprising:
a coating pressure feed roller;
coating-material press feeding pipes for pressure feeding the interior of said coating pressure feed roller from both ends of said coating pressure feed roller;
an arm part for supporting said coating pressure feed roller at both ends of said coating pressure feed roller;
a turnable support mechanism for supporting said arm part such that said arm is rotatable in a plane parallel to a vertical surface including the axis of said coating pressure feed roller; and
a vertically movable support mechanism for supporting said arm part such that said arm part is vertically movable.

6. A curved-surface operable roller coating device in which said coating pressure feed roller defined in claim 5 is said coating pressure feed roller defined by any of claims 1 to 3.

7. An automatic coating apparatus of the roller type comprising:
a three-dimensionally moving robot being movable in three dimensional directions, said curved-surface operable roller coating device defined by claim 5 or 6 being attached to the tip of arms of said robot;
a robot control unit for controlling said three-dimensionally moving robot;
a pump control unit for controlling a flow rate of a coating material to be pressure fed to said curved-surface operable roller coating device.

8. A automated coating apparatus having a coating material tank supplied with a coating material from a coating material can, a coating device for coating a coating material on an object to be coated, a piping ranging from said coating material tank to said coating device, and a pump, provided in said piping, for feeding the coating material to said coating device, wherein said coating device comprising:
a coating pressure feed roller including a solid cylindrical body being solid except an axial center hole passed through the axial center of said solid cylindrical body, and radial holes radially extended from a plurality of positions of said axial center hole, and a roller brush applied to the outer periphery of said solid cylindrical body;
a curved-surface operable roller coating device including coating-material press feeding pipes connected to both ends of the axial center hole of said solid cylindrical body of said coating pressure feed roller, an arm part for supporting said coating pressure feed roller at both ends of said coating pressure feed roller, a turnable support mechanism for supporting said arm part such that said arm is rotatable in a plane parallel to a vertical surface including the axis of said coating pressure feed roller, and a vertically movable support mechanism for supporting said arm part such that said arm part is vertically movable;
a three-dimensionally moving robot being movable in three dimensional directions, said curved-surface operable roller coating device defined by claim 5 or 6 being attached to the tip of arms of said robot;
a robot control unit for controlling said three-dimensionally moving robot; and
a coating material flowrate control unit for controlling a flow rate of a coating material to be pressure fed to said curved-surface operable roller coating device.

9. A automated coating apparatus having a coating material tank supplied with a coating material from a coating material can, a coating device for coating a coating material on an object to be coated, a piping ranging from said coating material tank to said coating device, and a pump, provided in said piping, for feeding the coating material to said coating device, wherein said coating device comprising:
a coating pressure feed roller including a solid cylindrical body being solid except an axial center hole passed through the axial center of said solid cylindrical body, and radial holes radially extended from a plurality of positions of said axial center hole, and a roller brush applied to the outer periphery of said solid cylindrical body;
a curved-surface operable roller coating device including coating-material press feeding pipes connected to one end of the axial center hole of said solid cylindrical body of said coating pressure feed roller, an arm part for supporting said coating pressure feed roller at one end of said coating pressure feed roller, a turnable support mechanism for supporting said arm part such that said arm is rotatable in a plane parallel to a vertical surface including the axis of said coating pressure feed roller, and a vertically movable support mechanism for supporting said arm part such that said arm part is vertically movable;
a three-dimensionally moving robot being movable in three dimensional directions, said curved-surface operable roller coating device defined by claim 5 or 6 being attached to the tip of arms of said robot;
a robot control unit for controlling said three-dimensionally moving robot; and
a coating material flow rate control unit for controlling a flow rate of a coating material to be pressure fed to said curved-surface operable roller coating device.

10. A automated coating apparatus according to claim 8 or 9, wherein a solution filter for removing foreign matters mixed into the coating material is provided in said piping ranging from said coating material tank to said coating device.

11. A automated coating apparatus according to claim 8 or 9, wherein a liquid quantity stabilizer using a flow meter, for controlling a flow rate of coating material in order to eliminate a variation of a flow rate of coating material within said piping and to keep constant an amount of coating material coated by said coating device, is provided in said piping ranging from said coating material tank to said coating device.

12. A automated coating apparatus according to claim 8 or 9, wherein a heat exchanger for adjusting temperature of the coating material in said coating device to an optimum temperature and supplying said coating material temperature adjusted is provided in said piping ranging from said coating material tank to said coating device.

13. A automated coating apparatus according to claim 8 or 9, further comprising:
a return piping for returning the remaining coating material of said coating material having been fed from said coating material tank to said coating device, said remaining coating material being left while not used for coating.

14. A automated coating apparatus according to claim 8 or 9, wherein the fore end of said return piping is projected into a liquid level within said coating material tank and is bent in the circumferential direction along the sidewall said coating material tank.

15. A automated coating apparatus according to claim 8 or 9, further comprising:
a coating material color select valve provided in said piping ranging from said coating material tank to said coating device;
a piping for guiding a detergent from a detergent tank to said coating material color select valve; and
a pump, provided in said piping, for supplying a detergent to said coating material color select valve.

16. A coating method for coating an object to be coated in a manner that a roller is rolled while a coating material is pressure fed from the interior of said roller to the outer periphery thereof, in which a predetermined long area is coated from one end to the other end by said coating pressure feed roller, said coating pressure feed roller is stopped at said other end, to coat a long area adjacent to said long area, said coating pressure feed roller is moved to one of the ends of said adjacent long area, and said long area is coated again toward said other end, and said coating operations are sequentially repeated to finally coat a broad area,
wherein as a first step, an area of said broad area except an area as a maximum corresponding to a width of said coating pressure feed roller, which is located inside from said both ends of said broad area is entirely coated by said coating method, and as a second step, said coating pressure feed roller is rolled from a first long area to a final long area in said uncoated area, while discharging no coating material or a small amount of coating material.

17. A coating method according to claim 16, wherein said coating pressure feed roller is rolled while discharging no coating material or a small amount of coating material, in a final long area in said broad area.

18. A coating method according to claim 16, wherein as the amount of coating material stagnating at said end increases, the width of the uncoated area is increased.

19. A coating method in which flat and curved portions to which said coating pressure feed roller is followable, such as hood, roof, trunk, bumper, fender or door of an automobile, is coated by said coating method defined by any of claims 16 to 18, and portions where said coating pressure feed roller is not followable, is coated manually by a brush or a roller, or automatically by a coating robot including a small roller smaller than said coating pressure feed roller or a slit nozzle.

20. A coating method in use for an automobile, wherein in said coating method defined in claim 19 which includes at least one coating pressure feed roller for coating an object to be coated in a manner that a roller is rolled while a coating material is pressure fed from the interior of said roller to the outer periphery thereof, at least one of said hood, roof, trunk, bumper, fender and door is coated with a first coating pressure feed roller, and at least one of components other than said components coated by said first coating pressure feed roller is coated with a second coating pressure feed roller.
